(19) United States
(12) Patent Application Publication
(10) Pub. No.: US 2024/0270584 A1
(43) Pub. Date: Aug. 15, 2024

(54) ZEOLITE SYNTHESIS IN A CONTINUOUS FLOW REACTOR WITH A PULSATILE FLOW REGIME

(71) Applicant: BASF SE, Ludwigshafen am Rhein (DE)

(72) Inventors: Hannah SCHREYER, Ludwigshafen am Rhein (DE); Andrei-Nicolae PARVULESCU, Ludwigshafen am Rhein (DE); Ralf BOEHLING, Ludwigshafen am Rhein (DE); Christian RIEMANN, Ludwigshafen am Rhein (DE)

(21) Appl. No.: 18/569,345

(22) PCT Filed: Jun. 14, 2022
(86) PCT No.: PCT/EP2022/066151

§ 371 Date: Dec. 12, 2023

(30) Foreign Application Priority Data
Jun. 14, 2021 (EP) 21179243.7

(51) Int. Cl. C01B 39/06

(52) U.S. Cl. CPC C01B 39/06

(57) ABSTRACT

The present invention relates to a continuous process for the preparation of a zeolitic material comprising SiO2 in its framework structure, said process comprising (i) continuously preparing a mixture comprising one or more solvents, one or more structure directing agents, and one or more sources of SiO2; (ii) continuously feeding the mixture prepared in (i) into one or more continuous flow reactors; and (iii) heating the mixture in the one or more continuous flow reactors for continuously obtaining a zeolitic material comprising SiO2 in its framework structure; wherein the mixture contained in the one or more continuous flow reactors is subject to a pulsatile flow regime. The present invention also relates to a zeolitic material as obtainable and/or obtained according to said process and the use of the zeolite material as a molecular sieve, as an adsorbent, for ion-exchange, or as a catalyst and/or as a catalyst support.

### TECHNICAL FIELD

The present invention relates to a process for the preparation of a zeolitic material, as well as to a catalyst per se as obtainable or obtained according to said process. Furthermore, the present invention relates to the use of the zeolitic material, in particular as a catalyst.

### INTRODUCTION

The synthesis of zeolitic materials from simple starting compounds involves a complex process of self-organization which often necessitates special conditions such as elevated temperatures and/or pressure, wherein such reactions typically require the heating of starting materials under autogenous pressure for obtaining the zeolitic material after lengthy reaction times ranging from days to several weeks. Accordingly, due to the often harsh reaction conditions and the long reaction times, batch synthesis has long been the method of choice for synthesizing zeolitic materials. Batch reactions however present numerous limitations, in particular relative to the levels of space-time-yield which may be attained.

Efforts have accordingly been invested in finding improved batch reaction procedures as well as alternative methodologies which offer advantages to the classical batch synthetic procedures employed for the synthesis of zeolitic materials. One method which has been investigated in this respect involves the use of continuous stirred-tank reactors wherein the fluid reagents are continuously introduced at the top of a tank reactor, and the effluent containing the solid reaction product is continuously removed from the bottom of the tank reactor. Although said methodologies eliminate the need to empty the reaction vessel between batch runs under non-continuous conditions, the reaction times necessary for crystallization remain lengthy.

In view thereof, reactor geometries have been conceived which allow for a rapid synthesis of zeolitic materials. Thus, US 2016/0115039 A1 relates to a method for the continuous production of a zeolite in a tubular reactor displaying a low ratio of the volume to the lateral surface area. Similarly, Liu et al. in Angew. Chem. Int. Ed. 2015, 54, 5683-5687 discloses a continuous synthesis of high-silica zeolite SSZ-13 employing very short reaction times. Ju, J. et al. in Chemical Engineering Journal 2006, 116, 115-121 as well as Vandermeersch, T. et al. in Microporous and Mesoporous Materials 2016, 226, 133-139, on the other hand, respectively disclose the rapid synthesis of micron sized NaA zeolite in a continuous flow reactor setup. Liu, Z. et al. in Chemistry of Materials 2014, 26, 2327-2331 concerns an ultrafast continuous-flow synthesis of crystalline microporous aluminophophate AlPO₄-5. Slangen et al. “Continuous Synthesis of Zeolites using a Tubular Reactor”, 12^{th} International Zeolite Conference, Materials Research Society 1999 relates to the continuous syntheses of NaA zeolite, NaY zeolite, and silicalite-1 in a tubular reactor of 6 mm outer diameter (˜3 mm inner diameter) and variable length. Bebon, C. et al. in Microporous and Mesoporous Materials 2002, 53, 13-20 concerns a method for the synthesis of zeolites employing a guide tube contained in an autoclave, wherein the reaction mixture is conveyed through the guide tube with the aid of an Archimedes screw placed within the guide tube along its axis.

For reactions which do not necessitate high pressure, microwave-assisted procedures have been investigated such as Bonaccorsi, L. et al. in Microporous and Mesoporous Materials 2008, 112, 481-493 which relates to the continuous synthesis of zeolite LTA. Similarly, US 2001/0054549 A1 concerns a continuous process and apparatus for preparing inorganic materials employing microwaves.

WO 2020/109292 A1 concerns a process for continuous interzeolitic conversion, and WO 2020/025799 A relates to the continuous synthesis of a titanolsilicate material.

Although considerable progress has been made relative to the reaction efficiency in view of the use of continuous stirred-tank and multiple stage reactors, progress made in view of the reduction of the reaction times has been limited to reactor geometries applied on a lab-scale level. Furthermore, efforts made with respect to the reduction of reaction times remain highly limited with respect to economically viable durations of operation due to the clogging of the reactor, in particular due to the pronounced changes in the rheology of the reaction mixture which occur during zeolite synthesis. More specifically, upon heating in a tubular reactor with laminar flow, the synthesis gel will typically show high shear rates in the region near the wall, whereas the core will show almost no shear rate due to the slow rate of heat transfer towards the core, in part due to an insulating effect of the synthesis gel in the region near the wall. As a result, the synthesis gel displays large temperature gradients from the wall region towards the core, and large residence distribution times are observed. In view of the severe inhomogeneous treatment of the synthesis gel resulting for this situation, very long reactors would need to be employed in order to obtain degrees of crystallization which are satisfactory.

In this regard, WO 2019/101854 A relates to a process for the synthesis of zeolites in a reactor with a controlled velocity profile.

Nevertheless, despite the progress made with regard to the continuous synthesis of zeolitic materials, there remains a need for a process which avoids the problems of poor heat transfer and the ensuing inhomogeneous reaction conditions experienced by a synthesis gel in continuous flow reactors.

### DETAILED DESCRIPTION

It was therefore an object of the present invention to provide an improved process for preparing a zeolitic material which prevents the clogging of continuous flow reactors during the formation of zeolitic materials due to the drastic increase in viscosity during the crystallization process.

Thus, it has quite surprisingly been found that clogging may be prevented by using a pulsating flow regime with a defined shear rate.

Therefore, the present invention relates to a continuous process for the preparation of a zeolitic material comprising SiO₂ in its framework structure, said process comprising
(i) continuously preparing a mixture comprising one or more solvents, one or more structure directing agents, and one or more sources of SiO₂;
(ii) continuously feeding the mixture prepared in (i) into one or more continuous flow reactors; and
(iii) heating the mixture in the one or more continuous flow reactors for continuously obtaining a zeolitic material comprising SiO₂ in its framework structure;
wherein the mixture contained in the one or more continuous flow reactors is subject to a pulsatile flow regime.

Within the meaning of the present invention, a pulsatile flow preferably describes a harmonic change of pressure gradient along a tube or pipe, i.e. sinusoidal. In general, however, the pulsation of flow need not to be caused by harmonic motion, i.e. square, sawtooth or other profiles would also represent a pulsatile flow within the meaning of the present invention.

It is preferred that the maximum shear rate achieved by the pulsatile flow regime is in the range of from 0 to 2,500 s⁻¹, preferably of from 0 to 1,500 s⁻¹, more preferably of from 0 to 1000 s⁻¹, more preferably of from 0 to 700 s⁻¹, more preferably of from 0 to 500 s⁻¹, more preferably of from 0 to 400 s⁻¹, more preferably of from 0 to 300 s⁻¹, more preferably of from 0 to 250 s⁻¹, more preferably of from 0 to 200 s⁻¹, more preferably of from 0 to 150 s⁻¹, more preferably of from 0 to 100 s⁻¹, and more preferably of from 0 to 50 s⁻¹. According to the present invention, the maximum shear rate in the continuous flow reactor is preferably determined based on the volumetric or the mass flow rate. More specifically, departing from the measured mass flow rate, the previously measured material laws are applied in iterative mathematical models to calculate velocity profiles and ultimately shear rates. In particular, the maximum shear rate is preferably determined by a process which involves determining the non-newtonian shear thinning viscosity law by measurements in small scale lab equipment, preferably using a Schubspannungskontrolliertes Rotationsviskosimeter Physika MCR301. By applying force to the fluid a certain flow profile develops. The obtained law, i.e. mu=f(shear rate, temperature, composition), together with the information on the volumetric flow rate Q by operation conditions (e.g. from the use of displacement pumps and displacement pulsator) and the geometry of the reactor, is then implemented in a Fluid Dynamics Simulation tool, wherein preferably the state-of-the-art Ansys® Fluent CFD code is used. The shear rate is then calculated by the gradient of velocity.

It is preferred that after (i) and prior to (ii), the mixture prepared in (i) is homogenized, wherein homogenization is preferably achieved by stirring of the mixture. Furthermore, it is preferred that homogenization is conducted in two continuous stirred-tank reactors (CSTR), wherein the first CSTR is located upstream of the second CSTR in the continuous process, and the mixture obtained in the first CSTR is continuously fed into the second CSTR.

In case where homogenization is conducted in two continuous stirred-tank reactors (CSTR), wherein the first CSTR is located upstream of the second CSTR in the continuous process, and the mixture obtained in the first CSTR is continuously fed into the second CSTR, it is preferred that the first CSTR employs one or more stirring shafts respectively fitted with one or more baffles. Furthermore and independently thereof, it is preferred that the first CSTR is operated at a temperature in the range of from 20 to 120° C., preferably in the range of from 21 to 80° C., more preferably from 22 to 40° C., more preferably from 23 to 30° C., and more preferably from 24 to 26° C.

It is preferred that the first CSTR is operated at a pressure in the range of from 1 to 3 bar, preferably in the range of from 1 to 2.5 bar, more preferably from 1 to 2 bar, more preferably from 1 to 1.5 bar, and more preferably from 1 to 1.2 bar.

It is preferred that the first CSTR has a capacity in the range of from 10 to 1,000 L, preferably in the range of from 100 to 800 L, more preferably from 150 to 600 L, more preferably from 200 to 400 L, and more preferably from 240 to 260 L.

It is preferred that the second CSTR employs one or more stirring shafts respectively fitted with one or more spiral stirrers.

It is preferred that the second CSTR is operated at a temperature in the range of from 20 to 120° C., preferably in the range of from 21 to 80° C., more preferably from 22 to 40° C., more preferably from 23 to 30° C., and more preferably from 24 to 26° C.

It is preferred that the second CSTR is operated at a pressure in the range of from 1 to 3 bar, preferably in the range of from 1 to 2.5 bar, more preferably from 1 to 2 bar, more preferably from 1 to 1.5 bar, and more preferably from 1 to 1.2 bar.

It is preferred that the second CSTR has a capacity in the range of from 20 to 2,000 L, preferably in the range of from 200 to 1,200 L, more preferably from 300 to 800 L, more preferably from 450 to 550 L, and more preferably from 490 to 510 L.

It is preferred that in (ii) the mixture continuously prepared in (i) is continuously fed into the one or more continuous flow reactors at a rate of from 10 to 2,000 kg/h, preferably in the range of from 50 to 1200 kg/h, more preferably from 100 to 800 kg/h, more preferably from 150 to 400 kg/h, more preferably from 250 to 350 kg/h, and preferably from 290 to 310 kg/h.

It is preferred that in (ii), the mixture continuously prepared in (i) is continuously fed into 1 to 10 continuous flow reactors, preferably from 1 to 8 continuous flow reactors, more preferably 1 to 6 continuous flow reactors, more preferably 1 to 4 continuous flow reactors, and more preferably 2 to 3 continuous flow reactors.

It is preferred that in (ii), continuous feeding is achieved by pumping with one or more dosage pumps, preferably with one dosage pump per continuous flow reactor.

In case where in (ii), continuous feeding is achieved by pumping with one or more dosage pumps, it is preferred that the one or more dosage pumps are selected from dosage pumps which are able to build up more than the vapour pressure of the reaction mixture at reaction temperature, wherein preferably the one or more dosage pumps are piston diaphragm pumps, and more preferably piston diaphragm pumps with pulsation damper.

In case where in (ii), continuous feeding is achieved by pumping with one or more dosage pumps, it is preferred that each of the one or more dosage pumps are operated at a rate in the range of from 5 to 500 kg/h, preferably in the range of from 20 to 400 kg/h, more preferably from 40 to 300 kg/h, more preferably from 80 to 150 kg/h, and more preferably from 90 to 110 kg/h.

It is preferred that each of the one or more dosage pumps are operated at a pressure in the range of from 0.5 to 15 MPa, preferably from 1 to 10 MPa, more preferably from 1.5 to 8 MPa, more preferably from 2 to 6 MPa, more preferably from 2.5 to 5.5 MPa, more preferably from 3 to 5 MPa, more preferably from 3.5 to 4.5 MPa, and more preferably from 3.8 to 4.2 MPa, wherein the pressure refers to the pressure generated at the outlet of the one or more dosage pumps.

In case where each of the one or more dosage pumps are operated at a pressure in the range of from 0.5 to 15 MPa, wherein the pressure refers to the pressure generated at the outlet of the one or more dosage pumps, it is preferred that the pulsatile flow regime is achieved by a semi-continuous flow regime in, or in and against, the general direction of flow, wherein the general direction of flow is defined by an inlet end of each of the one or more continuous flow reactors into which the mixture prepared in (i) is continuously fed and an outlet end of each of the one or more continuous flow reactors from which the zeolitic material obtained in (iii) is continuously collected.

In case where the pulsatile flow regime is achieved by a semi-continuous flow regime in, or in and against, the general direction of flow, wherein the general direction of flow is defined by an inlet end of each of the one or more continuous flow reactors into which the mixture prepared in (i) is continuously fed and an outlet end of each of the one or more continuous flow reactors from which the zeolitic material obtained in (iii) is continuously collected, it is preferred that the pulsatile flow regime is achieved by a pulsating movement in, or in and against, the general direction of flow.

In case where the pulsatile flow regime is achieved by a pulsating movement in, or in and against, the general direction of flow, it is preferred that the frequency of the pulsation is in the range of from 0.001 to 1 s⁻¹ preferably of from 0.003 to 0.7 s⁻¹, more preferably of from 0.005 to 0.4 s⁻¹, more preferably of from 0.008 to 0.2 s⁻¹, more preferably of from 0.01 to 0.15 s⁻¹, more preferably of from 0.04 to 0.1 s⁻¹, and more preferably of from 0.05 to 0.07 s⁻¹.

It is preferred that the pulsatile flow regime is achieved by a periodic alternation of the direction of flow in and against the general direction of flow.

In case where the pulsatile flow regime is achieved by a periodic alternation of the direction of flow in and against the general direction of flow, it is preferred that the frequency of the alternation of the direction of flow is in the range of from 0.01 to 3 s⁻¹, preferably of from 0.03 to 2 s⁻¹, more preferably of from 0.05 to 1.5 s⁻¹, more preferably of from 0.08 to 1.2 s⁻¹, more preferably of from 0.1 to 1 s⁻¹, more preferably of from 0.15 to 0.8 s⁻¹, and more preferably of from 0.2 to 0.5 s⁻¹.

It is preferred that continuous feeding in (ii) is performed at a liquid hourly space velocity in the range of from 0.1 to 10 h^{31 1}, preferably in the range of from 0.5 to 8 h^{31 1}, more preferably from 1 to 6 h^{31 1}, more preferably from 1.25 to 4 h⁻¹ and more preferably from 1.5 to 2 h⁻¹.

It is preferred that in (iii) the mixture is heated to a temperature in the range of from 90 to 280° C., preferably in the range of from 100 to 270° C., more preferably from 150 to 260° C., more preferably from 200 to 265° C., and more preferably from 248 to 252° C.

It is preferred that in (iii) the mixture is heated under autogenous pressure, wherein preferably the pressure is in the range of from 0.5 to 15 MPa, more preferably from 1 to 10 MPa, more preferably from 1.5 to 8 MPa, more preferably from 2 to 6 MPa, more preferably from 2.5 to 5.5 MPa, more preferably from 3 to 5 MPa, more preferably from 3.5 to 4.5 MPa, and more preferably from 3.8 to 4.2 MPa.

It is preferred that in (ii) the mixture prepared in (i) is continuously fed into the one or more continuous flow reactors for a duration ranging from 5 to 365 d, preferably from 10 to 300 d, more preferably from 15 to 240 d, more preferably from 30 to 180 d, more preferably from 50 to 120 d, and more preferably from 80 to 100 d.

It is preferred that the mixture constituting the feed crystallized in (iii) consists of two liquid phases, wherein the first liquid phase is an aqueous phase comprising water, and the second liquid phase comprises a lubricating agent, wherein the lubricating agent preferably comprises one or more fluorinated compounds.

In case where the mixture constituting the feed crystallized in (iii) consists of two liquid phases, wherein the first liquid phase is an aqueous phase comprising water, and the second liquid phase comprises a lubricating agent, wherein the lubricating agent preferably comprises one or more fluorinated compounds, it is preferred that the lubricating agent comprises one or more fluorinated polymers, preferably one or more fluorinated polyethers, and more preferably one or more perfluorinated polyethers. Furthermore and independently thereof, it is preferred that the lubricating agent comprises one or more fluorocarbons, preferably one or more perfluorocarbons, more preferably the lubricating agent comprises perfluorodecalin.

It is preferred that the lubricating agent comprises liquid paraffin.

It is preferred that the volume of each of the one of more continuous flow reactors is in the range of from 0.5 to 1,000 L, preferably in the range of from 20 to 750 L, more preferably from 30 to 250 L, more preferably from 40 to 90 L, and more preferably from 49 to 51 L.

It is preferred that each of the one of more continuous flow reactors is selected among a tubular reactor, a ring reactor, and a continuously oscillating reactor, preferably among a plain tubular reactor, a tubular membrane reactor, a ring reactor, a continuously oscillating baffled reactor, and combinations thereof, wherein more preferably each of the one of more continuous flow reactors is a plain tubular reactor and/or a ring reactor, wherein more preferably each of the one of more continuous flow reactors is a plain tubular reactor.

It is preferred that each of the one of more continuous flow reactors is straight and/or comprises one or more curves with respect to the direction of flow, wherein preferably each of the one of more continuous flow reactors is straight and/or has a coiled form with respect to the direction of flow, wherein more preferably each of the one of more continuous flow reactors has a coiled form with respect to the direction of flow.

In case where each of the one of more continuous flow reactors is straight and/or comprises one or more curves with respect to the direction of flow, it is preferred that the inner diameter of the coil form is in the range of from 6 to 100 mm, preferably from 7 to 80 mm, more preferably of from 8 to 60 mm, more preferably of from 9 to 40 mm, more preferably of from 10 to 25 mm, and more preferably of from 15 to 10 mm.

It is preferred that each of the one of more continuous flow reactors is a tubular reactor, and wherein at least a portion of the tubular reactor is of a regular cylindrical form having a constant inner diameter perpendicular to the direction of flow, wherein the inner diameter is preferably in the range of from 5 to 250 mm, more preferably in the range of from 10 to 200 mm, more preferably from 15 to 150 mm, more preferably from 20 to 75 mm, and more preferably from 23 to 27 mm.

It is preferred that each of the one of more continuous flow reactors has a length in the range of from 1 to 500 m, preferably in the range of from 30 to 400 m, more preferably from 50 to 300 m, more preferably from 85 to 150 m, and more preferably from 98 to 102 m.

It is preferred that the wall of each of the one of more continuous flow reactors is made of a metallic material, wherein the metallic material comprises one or more metals selected from the group consisting of Ta, Cr, Fe, Ni, Cu, Al, Mo, and combinations and/or alloys of two or more thereof, preferably from the group consisting of Ta, Cr, Fe, Ni, Mo, and combinations and/or alloys of two or more thereof, preferably from the group consisting of Cr, Fe, Ni, Mo, and combinations and/or alloys of two or more thereof wherein preferably the metallic material comprises stainless steel, wherein more preferably the metallic material consists of stainless steel.

It is preferred that the surface of the inner wall of each of the one of more continuous flow reactors is lined with an organic polymer material, wherein the organic polymer material preferably comprises one or more polymers selected from the group consisting of fluorinated polyalkylenes and mixtures of two or more thereof, preferably from the group consisting of (C2-C3)polyalkylenes and mixtures of two or more thereof, preferably from the group consisting of fluorinated polyethylenes and mixtures of two or more thereof, wherein more preferably the polymer material comprises poly(tetrafluoroethylene), wherein more preferably the inner wall of each of the one of more continuous flow reactors is lined with poly(tetrafluoroethylene).

It is preferred that the surface of the inner wall of each of the one of more continuous flow reactors is lined with a polysiloxane, preferably with a polysiloxane including a building block having the formula [R₂SiO]ₙ, wherein R is preferably an organic group, more preferably an alkyl and/or phenyl group.

It is preferred that each of the one of more continuous flow reactors consists of a single stage.

It is preferred that the reaction mixture continuously exiting the one or more continuous flow reactors displays a solids content ranging from 2 to 50 wt. % based on 100 wt.-% of the reaction mixture, preferably from 4 to 40 wt.-%, more preferably from 6 to 30 wt.-%, more preferably from 10 to 20 wt.-%, and more preferably from 13 to 15 wt.-% based on 100 wt.-% of the reaction mixture.

It is preferred that the zeolitic material further comprises X₂O₃ in its framework structure, wherein X stands for a trivalent element, and wherein the mixture in (i) further comprises one or more sources of X₂O₃.

In case where the zeolitic material further comprises X₂O₃ in its framework structure, wherein X stands for a trivalent element, and wherein the mixture in (i) further comprises one or more sources of X₂O₃, it is preferred that X is selected from the group consisting of Al, B, In, Ga, and mixtures of two or more thereof, X preferably being Al and/or B, and more preferably being Al.

It is preferred that the one or more sources of SiO₂ and X₂O₃ comprises a first zeolitic material comprising SiO₂ and X₂O₃ in its framework structure, and

wherein in (iii) the mixture is heated in the one or more continuous flow reactors for obtaining a second zeolitic material comprising SiO₂ and X₂O₃ in its framework structure, wherein the second zeolitic material obtained in (iii) has a different type of framework structure than the first zeolitic material contained in the mixture prepared in (i).

In case where the one or more sources of SiO₂ and X₂O₃ comprises a first zeolitic material comprising SiO₂ and X₂O₃ in its framework structure, and

wherein in (iii) the mixture is heated in the one or more continuous flow reactors for obtaining a second zeolitic material comprising SiO₂ and X₂O₃ in its framework structure, wherein the second zeolitic material obtained in (iii) has a different type of framework structure than the first zeolitic material contained in the mixture prepared in (i), it is preferred that the first zeolitic material has an FAU-, GIS-, MOR-, LTA-, FER-, TON-, MTT-, BEA-, MEL-, MWW-, MFS-, and/or MFI-type framework structure, preferably an FAU-, GIS-, BEA-, and/or MFI-type framework structure, more preferably an FAU- and/or BEA-type framework structure, and more preferably an FAU-type framework structure.

It is preferred that the first zeolitic material having an FAU-type framework structure is selected from the group consisting of ZSM-3, Faujasite, [Al—Ge—O]-FAU, CSZ-1, ECR-30, Zeolite X, Zeolite Y, LZ-210, SAPO-37, ZSM-20, Na—X, US-Y, Na—Y, [Ga—Ge—O]-FAU, Li-LSX, [Ga—Al—Si—O]-FAU, and [Ga—Si—O]-FAU, including mixtures of two or more thereof, preferably from the group consisting of ZSM-3, Faujasite, CSZ-1, ECR-30, Zeolite X, Zeolite Y, LZ-210, ZSM-20, Na—X, US-Y, Na—Y, and Li-LSX, including mixtures of two or more thereof, more preferably from the group consisting of Faujasite, Zeolite X, Zeolite Y, Na—X, US-Y, and Na—Y, including mixtures of two or more thereof, more preferably from the group consisting of Faujasite, Zeolite X, and Zeolite Y, including mixtures of two or more thereof, wherein more preferably the first zeolitic material having an FAU-type framework structure comprises zeolite X and/or zeolite Y, preferably zeolite Y, wherein more preferably the first zeolitic material having an FAU-type framework structure is zeolite X and/or zeolite Y, preferably zeolite Y.

It is preferred that the second zeolitic material has a CHA-, AEI-, GME-, and/or MFI-type framework structure, preferably a CHA- and/or AEI-type framework structure, and more preferably a CHA-type framework structure.

It is preferred that the second zeolitic material obtained in (iii) has a CHA-type framework structure, wherein preferably the zeolitic material having a CHA-type framework structure is selected from the group consisting of Willhendersonite, ZYT-6, SAPO-47, Na-Chabazite, Chabazite, LZ218, Linde D, Linde R, SAPO-34, ZK-14, K-Chabazite, MeAPSO-47, Phi, DAF-5, UIO-21, |Li—Na| [Al—Si—O]-CHA, (Ni(deta)2)-UT-6, SSZ-13, and SSZ-62, including mixtures of two or more thereof, more preferably from the group consisting of ZYT-6, SAPO-47, Na-Chabazite, Chabazite, LZ-218, Linde D, Linde R, SAPO-34, ZK-14, K-Chabazite, Phi, DAF-5, UiO-21, SSZ-13, and SSZ-62, including mixtures of two or more thereof, more preferably from the group consisting of Chabazite, Linde D, Linde R, SAPO-34, SSZ-13, and SSZ-62, including mixtures of two or more thereof, more preferably from the group consisting of Chabazite, SSZ-13, and SSZ-62, including mixtures of two or three thereof, wherein more preferably the second zeolitic material obtained in (iii) comprises chabazite and/or SSZ-13, preferably SSZ-13, and wherein more preferably the second zeolitic material obtained in (iii) is chabazite and/or SSZ-13, preferably SSZ13.

It is preferred that independently from one another, the framework structure of the first zeolitic material displays a YO₂:X₂O₃ molar ratio ranging from 5 to 120, preferably from 8 to 80, more preferably from 10 to 50, more preferably from 15 to 40, more preferably from 20 to 30, more preferably from 22 to 28, and more preferably from 24 to 26.

It is preferred that the mixture prepared in (i) and heated in (iii) further comprises at least one source for OH⁻, wherein the mixture displays an OH⁻:SiO₂ molar ratio of hydroxide to SiO₂ in the framework structure of the first zeolitic material in the range of from 0.05 to 1, preferably from 0.1 to 0.7, more preferably from 0.3 to 0.6, more preferably from 0.4 to 0.55, more preferably from 0.45 to 0.5, more preferably from 0.46 to 0.49, and more preferably from 0.47 to 0.48.

It is preferred that the one or more solvents in the mixture prepared in (i) comprise water, preferably distilled water, wherein more preferably water is contained as the one or more solvents in the mixture prepared in (i), preferably distilled water.

In case where the one or more solvents in the mixture prepared in (i) comprise water, it is preferred that the H₂O:SiO₂ molar ratio of water to SiO₂ calculated as the oxide in the mixture prepared in (i) is in the range of from 3 to 50, preferably of from 7 to 40, more preferably of from 9 to 30, more preferably of from 11 to 25, more preferably of from 13 to 22, more preferably of from 15 to 20, more preferably of from 16 to 19, and more preferably of from 17 to 18.

It is preferred that the mixture prepared in (i) and heated in (iii) further comprises at least one source for OH⁻, wherein said at least one source for OH⁻ preferably comprises a metal hydroxide, more preferably a hydroxide of an alkali metal M, more preferably sodium and/or potassium hydroxide, and more preferably sodium hydroxide, wherein more preferably the at least one source for OH⁻ is sodium hydroxide.

It is preferred that the mixture prepared in (i) further comprises seed crystals, wherein preferably the seed crystals comprise a zeolitic material having a CHA-, AEI-, GME-, and/or MFI-type framework structure, wherein more preferably the seed crystals comprise a zeolitic material having a CHA-type and/or an AEI-type framework structure, wherein more preferably the zeolitic material of the seed crystals is obtainable and/or obtained according to any one of the particular and preferred embodiments of the present invention.

In case where the mixture prepared in (i) further comprises seed crystals, wherein preferably the seed crystals comprise a zeolitic material having a CHA-, AEI-, GME-, and/or MFI-type framework structure, it is preferred that the zeolitic material having a CHA-type framework structure comprised in the seed crystals is selected from the group consisting of Willhendersonite, ZYT-6, SAPO-47, Na-Chabazite, Chabazite, LZ-218, Linde D, Linde R, SAPO-34, ZK-14, K-Chabazite, MeAPSO-47, Phi, DAF-5, UIO-21, |Li—Na| [Al—Si—O]-CHA, (Ni(deta)2)-UT-6, SSZ-13, and SSZ-62, including mixtures of two or more thereof, preferably from the group consisting of ZYT-6, SAPO-47, Na-Chabazite, Chabazite, LZ-218, Linde D, Linde R, SAPO-34, ZK-14, K-Chabazite, Phi, DAF-5, UiO-21, SSZ-13, and SSZ-62, including mixtures of two or more thereof, more preferably from the group consisting of Chabazite, Linde D, Linde R, SAPO-34, SSZ-13, and SSZ-62, including mixtures of two or more thereof, more preferably from the group consisting of Chabazite, SSZ-13, and SSZ-62, including mixtures of two or three thereof, wherein more preferably the zeolitic material having a CHA-type framework structure comprised in the seed crystals is chabazite and/or SSZ-13, preferably SSZ-13. Furthermore and independently thereof, it is preferred that the amount of seed crystals in the mixture prepared in (i) and heated in (iii) ranges from 0.1 to 25 wt.-% based on 100 wt.-% of SiO₂ in the framework structure of the first zeolitic material, preferably from 0.5 to 15 wt.-%, more preferably from 1 to 10 wt.-%, more preferably from 2 to 7 wt.-%, more preferably from 3 to 6 wt.-%, and more preferably from 4 to 5 wt. % based on 100 wt.-% of SiO₂ in the framework structure of the first zeolitic material.

It is preferred that the one or more structure directing agents comprise one or more tetraalkylammonium cation R¹R²R³R⁴N⁺-containing compounds, wherein R¹, R², R³ and R⁴ independently from one another stand for alkyl.

In case where the one or more structure directing agents comprise one or more tetraalkylammonium cation R¹R²R³R⁴N⁺-containing compounds, wherein R¹, R², R³ and R⁴ independently from one another stand for alkyl, it is preferred that R⁴ stands for adamantyl and/or benzyl, preferably for 1-adamantyl.

In case where R⁴ stands for adamantyl and/or benzyl, preferably for 1-adamantyl, it is preferred that R¹, R², and R³ independently from one another stand for optionally substituted and/or optionally branched (C₁-C₆)alkyl, preferably (C₁-C₅)alkyl, more preferably (C₁-C₄)alkyl, more preferably (C₁-C₃)alkyl, and more preferably for optionally substituted methyl or ethyl, wherein more preferably R¹, R², and R³ independently from one another stand for optionally substituted methyl or ethyl, preferably unsubstituted methyl or ethyl, wherein more preferably R¹, R², and R³ independently from one another stand for optionally substituted methyl, preferably unsubstituted methyl. Furthermore and independently thereof, it is preferred that R⁴ stands for optionally heterocyclic and/or optionally substituted adamantyl and/or benzyl, preferably for optionally heterocyclic and/or optionally substituted 1-adamantyl, more preferably for optionally substituted adamantyl and/or benzyl, more preferably for optionally substituted 1-adamantyl, more preferably for unsubstituted adamantyl and/or benzyl, and more preferably for unsubstituted 1-adamantyl.

It is preferred that the one or more tetraalkylammonium cation R¹R²R³R⁴N⁺-containing compounds comprise one or more N,N,N-tri(C₁-C₄)alkyl-1-adamantammonium compounds, preferably one or more N,N,N-tri(C₁-C₃)alkyl-1-adamantammonium compounds, more preferably one or more N,N,N-tri(C₁-C₂)alkyl-1-adamantammonium compounds, more preferably one or more N,N,N-tri(C₁-C₂)alkyl-1-adamantammonium and/or one or more N,N,N-tri(C₁-C₂)alkyl-1-adamantammonium compounds, more preferably one or more compounds selected from N,N,N-triethyl-1-adamantammonium, N,N-diethyl-N-methyl-1-adamantammonium, N,N-dimethyl-N-ethyl-1-adamantammonium, N,N,N-trimethyl-1-adamantammonium compounds, and mixtures of two or more thereof, wherein more preferably the one or more tetraalkylammonium cation R¹R²R³R⁴N⁺-containing compounds comprise one or more N,N,N-trimethyl-1-adamantammonium compounds.

It is preferred that the one or more tetraalkylammonium cation R¹R²R³R⁴N⁺-containing compounds are salts, preferably one or more salts selected from the group consisting of halides, sulfate, nitrate, phosphate, acetate, and mixtures of two or more thereof, more preferably from the group consisting of bromide, chloride, hydroxide, sulfate, and mixtures of two or more thereof, wherein more preferably the one or more tetraalkylammonium cation R¹R²R³R⁴N⁺-containing compounds are tetraalkylammonium hydroxides and/or sulfates, and more preferably tetraalkylammonium hydroxides.

In case where the one or more structure directing agents comprise one or more tetraalkylammonium cation R¹R²R³R⁴N⁺-containing compounds, wherein R¹, R², R³ and R⁴ independently from one another stand for alkyl, it is preferred that R⁴ stands for cycloalkyl.

In case where R⁴ stands for cycloalkyl, it is preferred that R¹ and R² independently from one another stand for optionally substituted and/or optionally branched (C₁-C₆)alkyl, preferably (C₁-C₅)alkyl, more preferably (C₁-C₄)alkyl, more preferably (C₁-C₃)alkyl, and more preferably for optionally substituted methyl or ethyl, wherein more preferably R¹ and R² independently from one another stand for optionally substituted methyl or ethyl, preferably unsubstituted methyl or ethyl, wherein more preferably R¹ and R² independently from one another stand for optionally substituted methyl, preferably unsubstituted methyl.

It is preferred that R³ stands for optionally substituted and/or optionally branched (C₁-C₆)alkyl, preferably (C₁-C₅)alkyl, more preferably (C₁-C₄)alkyl, more preferably (C₁-C₃)alkyl, and more preferably for optionally substituted methyl or ethyl, wherein more preferably R³ stands for optionally substituted ethyl, preferably unsubstituted ethyl.

It is preferred that R⁴ stands for optionally heterocyclic and/or optionally substituted 5- to 8-membered cycloalkyl, preferably for 5- to 7-membered cycloalkyl, more preferably for 5- or 6-membered cycloalkyl, wherein more preferably R⁴ stands for optionally heterocyclic and/or optionally substituted 6-membered cycloalkyl, preferably optionally substituted cyclohexyl, and more preferably unsubstituted cyclohexyl.

It is preferred that the one or more tetraalkylammonium cation R¹R²R³R⁴N⁺-containing compounds comprise one or more N,N,N-tri(C₁-C₄)alkyl-(C₅-C₇)cycloalkylammonium compounds, preferably one or more N,N,N-tri(C₁-C₃)alkyl-(C₅-C₆)cycloalkylammonium compounds, more preferably one or more N,N,N-tri(C₁-C₂)alkyl-(C₅-C₆)cycloalkylammonium compounds, more preferably one or more N,N,N-tri(C₁-C₂)alkyl-cyclopentylammonium and/or one or more N,N,N-tri(C₁-C₂)alkyl-cyclohexylammonium compounds, more preferably one or more compounds selected from N,N,N-triethyl-cyclohexylammonium, N,N-diethyl-N-methyl-cyclohexylammonium, N,N-dimethyl-N-ethyl-cyclohexylammonium, N,N,N-trimethyl-cyclohexylammonium compounds, and mixtures of two or more thereof, wherein more preferably the one or more tetraalkylammonium cation R¹R²R³R⁴N⁺-containing compounds comprise one or more N,N-dimethyl-N-ethyl-cyclohexylammonium compounds.

It is preferred that the one or more tetraalkylammonium cation R¹R²R³R⁴N⁺-containing compounds are salts, preferably one or more salts selected from the group consisting of halides, sulfate, nitrate, phosphate, acetate, and mixtures of two or more thereof, more preferably from the group consisting of bromide, chloride, hydroxide, sulfate, and mixtures of two or more thereof, wherein more preferably the one or more tetraalkylammonium cation R¹R²R³R⁴N⁺-containing compounds are tetraalkylammonium hydroxides and/or sulfates, and more preferably tetraalkylammonium hydroxides.

It is preferred that the one or more structure directing agents comprises one or more tetraalkylammonium cation R¹R²R³R⁴N⁺-containing compounds, and wherein the mixture prepared in (i) and heated in (iii) displays an R¹R²R³R⁴N⁺:SiO₂ molar ratio of the one or more tetraalkylammonium cations to SiO₂ in the framework structure of the first zeolitic material in the range of from 0.05 to 1.5, preferably from 0.1 to 0.8, more preferably from 0.3 to 0.5, more preferably from 0.5 to 0.3, more preferably from 0.7 to 0.2, more preferably from 0.8 to 0.15, more preferably from 0.85 to 0.12, more preferably from 0.9 to 0.11, and more preferably from 0.95 to 0.1.

It is preferred that in (iii) the mixture is heated to a temperature in the range of from 70 to 300° C., preferably of from 90 to 280° C., more preferably of from 120 to 250° C., more preferably of from 140 to 230° C., more preferably of from 160 to 220° C., more preferably of from 180 to 210° C., and more preferably of from 190 to 200° C.

It is preferred that the zeolitic material further comprises TiO₂ in its framework structure, wherein the mixture in (i) further comprises one or more sources of TiO₂, and wherein the one or more structure directing agents preferably comprise one or more tetraalkylammonium cation R¹R²R³R⁴N⁺-containing compounds, wherein R¹, R², R³ and R⁴ independently from one another stand for alkyl.

In case where the zeolitic material further comprises TiO₂ in its framework structure, wherein the mixture in (i) further comprises one or more sources of TiO₂, it is preferred that the zeolitic material obtained in (iii) has a framework structure type selected from the group consisting of MFI, MEL, IMF, SVY, FER, SVR, and intergrowth structures of two or more thereof, wherein preferably the zeolitic material obtained in (iii) has an MFI- and/or MEL-type framework structure, preferably an MFI-type framework structure.

It is preferred that the one or more solvents in the mixture prepared in (i) comprise water, preferably distilled water, wherein more preferably water is contained as the one or more solvents in the mixture prepared in (i), preferably distilled water.

In case where the one or more solvents in the mixture prepared in (i) comprise water, it is preferred that the H₂O:Si molar ratio of water to the one or more sources of Si calculated as SiO₂ in the mixture prepared in (i) is in the range of from 2 to 13, preferably from 3 to 11, more preferably from 4 to 10, more preferably from 4.5 to 9.5, more preferably from 5 to 9, more preferably from 5.5 to 8.5, more preferably from 6 to 8, and more preferably from 6.5 to 7.5.

It is preferred that R¹, R², R³, and R⁴ independently from one another stand for optionally branched (C₁-C₆)alkyl, preferably (C₁-C₅)alkyl, more preferably (C₂-C₄)alkyl, and more preferably for optionally branched (C₂-C₃)alkyl, wherein more preferably R¹, R², R³, and R⁴ independently from one another stand for ethyl or propyl, wherein more preferably R¹, R², R³, and R⁴ stand for propyl, preferably for n-propyl.

It is preferred that independently of one another the one or more tetraalkylammonium cation R¹R²R³R⁴N⁺-containing compounds are salts, preferably one or more salts selected from the group consisting of halides, preferably chloride and/or bromide, more preferably chloride, hydroxide, sulfate, nitrate, phosphate, acetate, and mixtures of two or more thereof, more preferably from the group consisting of chloride, hydroxide, sulfate, and mixtures of two or more thereof, wherein more preferably the one or more tetraalkylammonium cation R¹R²R³R⁴N⁺-containing compounds are tetraalkylammonium hydroxides and/or chlorides, and more preferably tetraalkylammonium hydroxides.

It is preferred that the mixture prepared in (i) and crystallized in (iii) displays a molar ratio of the one or more tetraalkylammonium cation R¹R²R³R⁴N⁺-containing compounds to the one or more sources of Si calculated as SiO₂ in the range of from 0.001 to 1.5, preferably from 0.005 to 1, more preferably from 0.01 to 0.7, more preferably from 0.05 to 0.5, more preferably from 0.07 to 0.4, more preferably from 0.1 to 0.3, more preferably from 0.13 to 0.25, more preferably from 0.15 to 0.22, and even more preferably from 0.17 to 0.19.

It is preferred that the one or more sources of SiO₂ comprises one or more compounds selected from the group consisting of silicas, silicates, and mixtures thereof,

preferably from the group consisting of fumed silica, silica hydrosols, reactive amorphous solid silicas, silica gel, silicic acid, water glass, sodium metasilicate hydrate, sesquisilicate, disilicate, colloidal silica, pyrogenic silica, silicic acid esters, tetraalkoxysilanes, and mixtures of two or more thereof,
more preferably from the group consisting of silica hydrosols, silica gel, silicic acid, water glass, sodium metasilicate hydrate, colloidal silica, silicic acid esters, tetraalkoxysilanes, and mixtures of two or more thereof,
more preferably from the group consisting of silica hydrosols, silicic acid, colloidal silica, silicic acid esters, tetraalkoxysilanes, and mixtures of two or more thereof,
wherein more preferably the one or more sources of SiO₂ comprise one or more tetraalkoxysilanes selected from the group consisting of (C₁-C₆)tetraalkoxysilanes and mixtures of two or more thereof, preferably (C₁-C₅)tetraalkoxysilanes and mixtures of two or more thereof, more preferably (C₁-C₄)tetraalkoxysilanes and mixtures of two or more thereof, more preferably (C₁-C₃)tetraalkoxysilanes and mixtures of two or more thereof, wherein more preferably the one or more sources of SiO₂ comprise tetramethoxysilane and/or tetraethoxysilane, preferably tetraethoxysilane, and wherein more preferably the one or more sources of Si is tetramethoxysilane and/or tetraethoxysilane, preferably tetraethoxysilane.

It is preferred that the one or more sources of Ti comprises one or more compounds selected from the group consisting of titanium oxides, titanium salts, titanyl compounds, titanic acids, titanic acid esters, and mixtures of two or more thereof, preferably one or more compounds selected from the group consisting of tetrabutyl orthotitanate, tetraisopropyl orthotitanate, tetraethyl orthotitanate, titanium dioxide, titanium tetrachloride, titanium tert-butoxide, TiOSO₄ and/or KTiOPO₄, and a mixture of two or more thereof, more preferably from the group consisting of tetrabutyl orthotitanate, tetraisopropyl orthotitanate, tetraethyl orthotitanate, titanium dioxide, titanium tetrachloride, titanium tert-butoxide, and a mixture of two or more thereof, the titanium source preferably being tetramethyl and/or tetraethyl orthotitanate, more preferably tetraethyl orthotitanate.

It is preferred that the SiO₂:TiO₂ molar ratio of the one or more sources of SiO₂, calculated as SiO₂, to the one or more sources of TiO₂, calculated as TiO₂, of the mixture prepared in (i) ranges from 1 to 500, preferably from 2 to 200, more preferably from 5 to 150, more preferably from 10 to 100, more preferably from 20 to 70, more preferably from 25 to 50, more preferably from 30 to 45, and more preferably from 35 to 40.

It is preferred that in (iii) the mixture is heated to a temperature in the range of from 90 to 280° C., preferably of from 110 to 250° C., more preferably of from 130 to 220° C., more preferably of from 150 to 200° C., more preferably of from 160 to 190° C., and more preferably of from 170 to 180° C.

It is preferred that prior to (ii) the mixture prepared in (i) is aged at a temperature in the range of from 40 to 120° C., preferably from 50 to 115° C., more preferably from 60 to 110° C., more preferably from 70 to 105° C., more preferably from 80 to 100° C., and more preferably from 85 to 95° C.

It is preferred that prior to (ii) the mixture prepared in (i) is aged for a duration ranging from 0.05 to 48 h, more preferably from 0.15 to 24 h, more preferably from 0.25 to 12 h, more preferably from 0.5 to 6 h, more preferably from 0.75 to 3 h, more preferably from 1 to 2 h, and more preferably from 1.25 to 1.75 h.

It is preferred that the process further comprises
(iv) concentrating the zeolitic material obtained in (iii), preferably by filtration, more preferably by membrane filtration, and more preferably by cross-flow filtration;
and/or, preferably and,
(v) washing the zeolitic material obtained in (iii) or (iv) with a liquid comprising one or more solvents;
and/or, preferably and,
(vi) drying the zeolitic material obtained in (iii), (iv) or (v);
and/or, preferably and,
(vii) calcining the zeolitic material obtained in (iii), (iv), (v) or (vi).

In case where the process further comprises
(iv) concentrating the zeolitic material obtained in (iii), preferably by filtration, more preferably by membrane filtration, and more preferably by cross-flow filtration;
and/or, preferably and,
(v) washing the zeolitic material obtained in (iii) or (iv) with a liquid comprising one or more solvents;
and/or, preferably and,
(vi) drying the zeolitic material obtained in (iii), (iv) or (v);
and/or, preferably and,
(vii) calcining the zeolitic material obtained in (iii), (iv), (v) or (vi), it is preferred that concentrating in (iv) and washing in (v) is performed simultaneously in two or more sequential stages of membrane filtration, preferably in 2 to 10 stages, more preferably from 3 to 8, more preferably from 3 to 7, more preferably from 4 to 6, and more preferably from 4 to 5, wherein the retentate of one stage of membrane filtration is diluted with the liquid comprising one or more solvents when being fed to the subsequent stage.

In case where concentrating in (iv) and washing in (v) is performed simultaneously in two or more sequential stages of membrane filtration, wherein the retentate of one stage of membrane filtration is diluted with the liquid comprising one or more solvents when being fed to the subsequent stage, it is preferred that the permeate of the first stage of membrane filtration comprising a portion of the one or more structure directing agents from the mixture continuously prepared in (i) is continuously recycled to (i).

It is preferred that membrane filtration is conducted at a pressure in the range of from 0.2 to 60 bar, preferably from 0.5 to 20 bar, more preferably of from 1 to 15 bar, more preferably of from 3 to 12 bar, and more preferably of from 5 to 8 bar.

It is preferred that membrane filtration is conducted at a temperature in the range of from 20 to 200° C., preferably in the range of from 50 to 150° C., more preferably from 80 to 120° C., more preferably from 90 to 110° C., and more preferably from 97 to 103° C.

It is preferred that the membrane filtration is a cross-flow filtration.

In case where the membrane filtration is a cross-flow filtration, it is preferred that the cross-flow filtration is performed in one or more sequential cross-flow filtration units, preferably in 1 to 10 sequential cross-flow filtration units, more preferably in 2 to 9 sequential cross-flow filtration units, more preferably in 3 to 8 sequential cross-flow filtration units, more preferably in 4 to 6 sequential cross-flow filtration units, and more preferably in 4 to 5 sequential cross-flow filtration units.

In case where the cross-flow filtration is performed in one or more sequential cross-flow filtration units, it is preferred that each of the one or more sequential cross-flow filtration units comprises from 10 to 10,000 tubes, preferably from 250 to 7,500 tubes, more preferably from 500 to 5,000 tubes, more preferably from 750 to 2,500 tubes, and more preferably from 975 to 1025 tubes.

In case where each of the one or more sequential cross-flow filtration units comprises from 10 to 10,000 tubes, it is preferred that the inner diameter of the tubes is in the range of from 2 to 25 mm, preferably in the range of from 3 to 20 mm, more preferably form 4 to 15 mm, more preferably from 5 to 10 mm, and more preferably from 5.5 to 6.5 mm.

It is preferred that in (v) the liquid comprises one or more solvents selected from the group consisting of polar protic solvents and mixtures thereof, preferably from the group consisting of n-butanol, isopropanol, propanol, ethanol, methanol, water, and mixtures thereof, more preferably from the group consisting of ethanol, methanol, water, and mixtures thereof, wherein more preferably the liquid comprises water, and wherein more preferably water is used as the liquid, preferably deionized water.

It is preferred that drying in (vi) is effected at a temperature in the range from 50 to 220° C., preferably from 70 to 190° C., more preferably from 80 to 170° C., more preferably from 90 to 150° C., more preferably from 100 to 140° C., and more preferably from 110 to 130° C.

It is preferred that in (vi) drying of the zeolitic material includes a step of spray-drying the zeolitic material obtained in (iii), (iv) or (v).

In case where in (vi) drying of the zeolitic material includes a step of spray-drying the zeolitic material obtained in (iii), (iv) or (v), it is preferred that spray drying is effected with a drying gas having a temperature in the range from 100 to 500° C., preferably from 150 to 450° C., more preferably from 200 to 400° C., more preferably from 250 to 350° C., and more preferably from 275 to 325° C.

The present invention also relates to a zeolitic material as obtainable and/or obtained according to the process of any one of the particular and preferred embodiments of the present invention.

It is preferred that the zeolitic material has a CHA-type framework structure, wherein preferably the zeolitic material is selected from the group consisting of Willhendersonite, ZYT-6, SAPO-47, Na-Chabazite, Chabazite, LZ-218, Linde D, Linde R, SAPO-34, ZK-14, K-Chabazite, MeAPSO47, Phi, DAF-5, UIO-21, |Li-Na| [Al—Si—O]-CHA, (Ni(deta)2)-UT-6, SSZ-13, and SSZ-62, including mixtures of two or more thereof, more preferably from the group consisting of ZYT-6, SAPO-47, Na-Chabazite, Chabazite, LZ-218, Linde D, Linde R, SAPO-34, ZK-14, K-Chabazite, Phi, DAF5, UiO-21, SSZ-13, and SSZ-62, including mixtures of two or more thereof, more preferably from the group consisting of Chabazite, Linde D, Linde R, SAPO-34, SSZ-13, and SSZ-62, including mixtures of two or more thereof, more preferably from the group consisting of Chabazite, SSZ-13, and SSZ-62, including mixtures of two or three thereof, wherein more preferably the zeolitic material comprises chabazite and/or SSZ-13, preferably SSZ-13, and wherein more preferably the zeolitic material is chabazite and/or SSZ-13, preferably SSZ-13.

The present invention also related to a use of a zeolitic material according to any of the particular and preferred embodiments of the present invention as a molecular sieve, as an adsorbent, for ion-exchange, or as a catalyst and/or as a catalyst support, preferably as a catalyst and/or catalyst support for the selective catalytic reduction (SCR) of nitrogen oxides NOₓ; for the storage and/or adsorption of CO₂; for the oxidation of NH₃, in particular for the oxidation of NH₃ slip in diesel systems; for the decomposition of N₂O; as an additive in fluid catalytic cracking (FCC) processes; and/or as a catalyst and/or catalyst support in organic conversion reactions, preferably in the conversion of alcohols to olefins, and more preferably in methanol to olefin (MTO) catalysis; more preferably for the selective catalytic reduction (SCR) of nitrogen oxides NOₓ, and more preferably for the selective catalytic reduction (SCR) of nitrogen oxides NOₓ in exhaust gas from a combustion engine, preferably from a diesel engine or from a lean burn gasoline engine.

In case where the zeolitic material as obtainable and/or obtained according to the process of any one of the particular and preferred embodiments of the present invention, it is preferred that the zeolitic material has an MFI-type framework structure, wherein the zeolitic material having an MFI-type framework structure comprises TS-1, wherein more preferably the zeolitic material is TS-1.

The present invention also related to a use of a zeolitic material according to any of the particular and preferred embodiments of the present invention as a molecular sieve, as an adsorbent, for ion-exchange, or as a catalyst and/or as a catalyst support, preferably as a catalyst and/or catalyst support in a reaction involving C—C bond formation and/or conversion, and preferably as a catalyst and/or catalyst support in an isomerization reaction, in an ammoxidation reaction, in an amination reaction, in a hydrocracking reaction, in an alkylation reaction, in an acylation reaction, in a reaction for the conversion of alkanes to olefins, or in a reaction for the conversion of one or more oxygenates to olefins and/or aromatics, in a reaction for the synthesis of hydrogen peroxide, in an aldol condensation reaction, in a reaction for the isomerization of epoxides, in a transesterification reaction, or in an epoxidation reaction, preferably as a catalyst and/or catalyst support in a reaction for the epoxidation of olefins, more preferably in a reaction for the epoxidation of C₂-C₅ alkenes, more preferably in a reaction for the epoxidation of C₂-C₄ alkenes, in a reaction for the epoxidation of C₂ or C₃ alkenes, more preferably for the epoxidation of C₃ alkenes, and more preferably as a catalyst for the conversion of propylene to propylene oxide.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suitably structured part of the description directed to general and preferred aspects of the present invention.

1. A continuous process for the preparation of a zeolitic material comprising SiO₂ in its framework structure, said process comprising
(i) continuously preparing a mixture comprising one or more solvents, one or more structure directing agents, and one or more sources of SiO₂;
(ii) continuously feeding the mixture prepared in (i) into one or more continuous flow reactors; and
(iii) heating the mixture in the one or more continuous flow reactors for continuously obtaining a zeolitic material comprising SiO₂ in its framework structure;
wherein the mixture contained in the one or more continuous flow reactors is subject to a pulsatile flow regime.

2. The continuous process of embodiment 1, wherein the maximum shear rate achieved by the pulsatile flow regime is in the range of from 0 to 2,500 s⁻¹, preferably of from 0 to 1,500 s⁻¹, more preferably of from 0 to 1000 s⁻¹, more preferably of from 0 to 700 s⁻¹, more preferably of from 0 to 500 s⁻¹, more preferably of from 0 to 400 s⁻¹, more preferably of from 0 to 300 s⁻¹, more preferably of from 0 to 250 s⁻¹, more preferably of from 0 to 200 s⁻¹, more preferably of from 0 to 150 s⁻¹, more preferably of from 0 to 100 s⁻¹, and more preferably of from 0 to 50 s⁻¹.

3. The continuous process of embodiment 1 or 2, wherein after (i) and prior to (ii), the mixture prepared in (i) is homogenized, wherein homogenization is preferably achieved by stirring of the mixture.

4. The continuous process of claim 3, wherein homogenization is conducted in two continuous stirred-tank reactors (CSTR), wherein the first CSTR is located upstream of the second CSTR in the continuous process, and the mixture obtained in the first CSTR is continuously fed into the second CSTR.

5. The continuous process of embodiment 4, wherein the first CSTR employs one or more stirring shafts respectively fitted with one or more baffles.

6. The continuous process of embodiment 4 or 5, wherein the first CSTR is operated at a temperature in the range of from 20 to 120° C., preferably in the range of from 21 to 80° C., more preferably from 22 to 40° C., more preferably from 23 to 30° C., and more preferably from 24 to 26° C.

7. The continuous process of any of embodiments 4 to 6, wherein the first CSTR is operated at a pressure in the range of from 1 to 3 bar, preferably in the range of from 1 to 2.5 bar, more preferably from 1 to 2 bar, more preferably from 1 to 1.5 bar, and more preferably from 1 to 1.2 bar.

8. The continuous process of any of embodiments 4 to 7, wherein the first CSTR has a capacity in the range of from 10 to 1,000 L, preferably in the range of from 100 to 800 L, more preferably from 150 to 600 L, more preferably from 200 to 400 L, and more preferably from 240 to 260 L.

9. The continuous process of any of embodiments 4 to 8, wherein the second CSTR employs one or more stirring shafts respectively fitted with one or more spiral stirrers.

10. The continuous process of any of embodiments 4 to 9, wherein the second CSTR is operated at a temperature in the range of from 20 to 120° C., preferably in the range of from 21 to 80° C., more preferably from 22 to 40° C., more preferably from 23 to 30° C., and more preferably from 24 to 26° C.

11. The continuous process of any of embodiments 4 to 10, wherein the second CSTR is operated at a pressure in the range of from 1 to 3 bar, preferably in the range of from 1 to 2.5 bar, more preferably from 1 to 2 bar, more preferably from 1 to 1.5 bar, and more preferably from 1 to 1.2 bar.

12. The continuous process of any of embodiments 4 to 11, wherein the second CSTR has a capacity in the range of from 20 to 2,000 L, preferably in the range of from 200 to 1,200 L, more preferably from 300 to 800 L, more preferably from 450 to 550 L, and more preferably from 490 to 510 L.

13. The continuous process of any of embodiments 1 to 12, wherein in (ii) the mixture continuously prepared in (i) is continuously fed into the one or more continuous flow reactors at a rate of from 10 to 2,000 kg/h, preferably in the range of from 50 to 1200 kg/h, more preferably from 100 to 800 kg/h, more preferably from 150 to 400 kg/h, more preferably from 250 to 350 kg/h, and preferably from 290 to 310 kg/h.

14. The continuous process of any of embodiments 1 to 13, wherein in (ii), the mixture continuously prepared in (i) is continuously fed into 1 to 10 continuous flow reactors, preferably from 1 to 8 continuous flow reactors, more preferably 1 to 6 continuous flow reactors, more preferably 1 to 4 continuous flow reactors, and more preferably 2 to 3 continuous flow reactors.

15. The continuous process of any of embodiments 1 to 14, wherein in (ii), continuous feeding is achieved by pumping with one or more dosage pumps, preferably with one dosage pump per continuous flow reactor.

16. The continuous process of embodiment 15, wherein the one or more dosage pumps are selected from dosage pumps which are able to build up more than the vapour pressure of the reaction mixture at reaction temperature, wherein preferably the one or more dosage pumps are piston diaphragm pumps, and more preferably piston diaphragm pumps with pulsation damper.

17. The continuous process of embodiment 15 or 16, wherein each of the one or more dosage pumps are operated at a rate in the range of from 5 to 500 kg/h, preferably in the range of from 20 to 400 kg/h, more preferably from 40 to 300 kg/h, more preferably from 80 to 150 kg/h, and more preferably from 90 to 110 kg/h.

18. The continuous process of any of embodiments 15 to 17, wherein each of the one or more dosage pumps are operated at a pressure in the range of from 0.5 to 15 MPa, preferably from 1 to 10 MPa, more preferably from 1.5 to 8 MPa, more preferably from 2 to 6 MPa, more preferably from 2.5 to 5.5 MPa, more preferably from 3 to 5 MPa, more preferably from 3.5 to 4.5 MPa, and more preferably from 3.8 to 4.2 MPa, wherein the pressure refers to the pressure generated at the outlet of the one or more dosage pumps.

19. The continuous process of any of embodiments 1 to 18, wherein the pulsatile flow regime is achieved by a semi-continuous flow regime in, or in and against, the general direction of flow, wherein the general direction of flow is defined by an inlet end of each of the one or more continuous flow reactors into which the mixture prepared in (i) is continuously fed and an outlet end of each of the one or more continuous flow reactors from which the zeolitic material obtained in (iii) is continuously collected.

20. The continuous process of embodiment 19, wherein the pulsatile flow regime is achieved by a pulsating movement in, or in and against, the general direction of flow.

21. The continuous process of embodiment 20, wherein the frequency of the pulsation is in the range of from 0.001 to 1 s⁻¹, preferably of from 0.003 to 0.7 s⁻¹, more preferably of from 0.005 to 0.4 s⁻¹, more preferably of from 0.008 to 0.2 s⁻¹, more preferably of from 0.01 to 0.15 s⁻¹, more preferably of from 0.04 to 0.1 s⁻¹, and more preferably of from 0.05 to 0.07 s⁻¹.

22. The continuous process of any of embodiments 19 to 21, wherein the pulsatile flow regime is achieved by a periodic alternation of the direction of flow in and against the general direction of flow.

23. The continuous process of embodiment 22, wherein the frequency of the alternation of the direction of flow is in the range of from 0.01 to 3 s⁻¹, preferably of from 0.03 to 2 s⁻¹, more preferably of from 0.05 to 1.5 s⁻¹, more preferably of from 0.08 to 1.2 s⁻¹, more preferably of from 0.1 to 1 s⁻¹, more preferably of from 0.15 to 0.8 s⁻¹, and more preferably of from 0.2 to 0.5 s⁻¹.

24. The continuous process of any of embodiments 1 to 23, wherein continuous feeding in (ii) is performed at a liquid hourly space velocity in the range of from 0.1 to 10 h^{31 1}, preferably in the range of from 0.5 to 8 h^{31 1}, more preferably from 1 to 6 h^{31 1}, more preferably from 1.25 to 4 h⁻¹ and more preferably from 1.5 to 2 h⁻¹.

25. The continuous process of any of embodiments 1 to 24, wherein in (iii) the mixture is heated to a temperature in the range of from 90 to 280° C., preferably in the range of from 100 to 270° C., more preferably from 150 to 260° C., more preferably from 200 to 265° C., and more preferably from 248 to 252° C.

26. The continuous process of any of embodiments 1 to 25, wherein in (iii) the mixture is heated under autogenous pressure, wherein preferably the pressure is in the range of from 0.5 to 15 MPa, more preferably from 1 to 10 MPa, more preferably from 1.5 to 8 MPa, more preferably from 2 to 6 MPa, more preferably from 2.5 to 5.5 MPa, more preferably from 3 to 5 MPa, more preferably from 3.5 to 4.5 MPa, and more preferably from 3.8 to 4.2 MPa.

27. The continuous process of any of embodiments 1 to 26, wherein in (ii) the mixture prepared in (i) is continuously fed into the one or more continuous flow reactors for a duration ranging from 5 to 365 d, preferably from 10 to 300 d, more preferably from 15 to 240 d, more preferably from 30 to 180 d, more preferably from 50 to 120 d, and more preferably from 80 to 100 d.

28. The continuous process of any of embodiments 1 to 27, wherein the mixture constituting the feed crystallized in (iii) consists of two liquid phases, wherein the first liquid phase is an aqueous phase comprising water, and the second liquid phase comprises a lubricating agent, wherein the lubricating agent preferably comprises one or more fluorinated compounds.

29. The continuous process of embodiment 28, wherein the lubricating agent comprises one or more fluorinated polymers, preferably one or more fluorinated polyethers, and more preferably one or more perfluorinated polyethers.

30. The continuous process of embodiment 28 or 29, wherein the lubricating agent comprises one or more fluorocarbons, preferably one or more perfluorocarbons, more preferably the lubricating agent comprises perfluorodecalin.

31. The continuous process of any of embodiments 28 to 30, wherein the lubricating agent comprises liquid paraffin.

32. The continuous process of any of embodiments 1 to 31, wherein the volume of each of the one of more continuous flow reactors is in the range of from 0.5 to 1,000 L, preferably in the range of from 20 to 750 L, more preferably from 30 to 250 L, more preferably from 40 to 90 L, and more preferably from 49 to 51 L.

33. The continuous process of any of embodiments 1 to 32, wherein each of the one of more continuous flow reactors is selected among a tubular reactor, a ring reactor, and a continuously oscillating reactor, preferably among a plain tubular reactor, a tubular membrane reactor, a ring reactor, a continuously oscillating baffled reactor, and combinations thereof, wherein more preferably each of the one of more continuous flow reactors is a plain tubular reactor and/or a ring reactor, wherein more preferably each of the one of more continuous flow reactors is a plain tubular reactor.

34. The continuous process of any of embodiments 1 to 33, wherein each of the one of more continuous flow reactors is straight and/or comprises one or more curves with respect to the direction of flow, wherein preferably each of the one of more continuous flow reactors is straight and/or has a coiled form with respect to the direction of flow, wherein more preferably each of the one of more continuous flow reactors has a coiled form with respect to the direction of flow.

35. The continuous process of embodiment 34, wherein the inner diameter of the coil form is in the range of from 6 to 100 mm, preferably from 7 to 80 mm, more preferably of from 8 to 60 mm, more preferably of from 9 to 40 mm, more preferably of from 10 to 25 mm, and more preferably of from 15 to 10 mm.

36. The continuous process of any of embodiments 1 to 35, wherein each of the one of more continuous flow reactors is a tubular reactor, and wherein at least a portion of the tubular reactor is of a regular cylindrical form having a constant inner diameter perpendicular to the direction of flow, wherein the inner diameter is preferably in the range of from 5 to 250 mm, more preferably in the range of from 10 to 200 mm, more preferably from 15 to 150 mm, more preferably from 20 to 75 mm, and more preferably from 23 to 27 mm.

37. The continuous process of any of embodiments 1 to 36, wherein each of the one of more continuous flow reactors has a length in the range of from 1 to 500 m, preferably in the range of from 30 to 400 m, more preferably from 50 to 300 m, more preferably from 85 to 150 m, and more preferably from 98 to 102 m.

38. The continuous process of any of embodiments 1 to 37, wherein the wall of each of the one of more continuous flow reactors is made of a metallic material, wherein the metallic material comprises one or more metals selected from the group consisting of Ta, Cr, Fe, Ni, Cu, Al, Mo, and combinations and/or alloys of two or more thereof, preferably from the group consisting of Ta, Cr, Fe, Ni, Mo, and combinations and/or alloys of two or more thereof, preferably from the group consisting of Cr, Fe, Ni, Mo, and combinations and/or alloys of two or more thereof wherein preferably the metallic material comprises stainless steel, wherein more preferably the metallic material consists of stainless steel.

39. The continuous process of any of embodiments 1 to 38, wherein the surface of the inner wall of each of the one of more continuous flow reactors is lined with an organic polymer material, wherein the organic polymer material preferably comprises one or more polymers selected from the group consisting of fluorinated polyalkylenes and mixtures of two or more thereof, preferably from the group consisting of (C₂-C₃)polyalkylenes and mixtures of two or more thereof, preferably from the group consisting of fluorinated polyethylenes and mixtures of two or more thereof, wherein more preferably the polymer material comprises poly(tetrafluoroethylene), wherein more preferably the inner wall of each of the one of more continuous flow reactors is lined with poly(tetrafluoroethylene).

40. The continuous process of any of embodiments 1 to 39, wherein the surface of the inner wall of each of the one of more continuous flow reactors is lined with a polysiloxane, preferably with a polysiloxane including a building block having the formula [R₂SiO]ₙ, wherein R is preferably an organic group, more preferably an alkyl and/or phenyl group.

41. The continuous process of any of embodiments 1 to 40, wherein each of the one of more continuous flow reactors consists of a single stage.

42. The continuous process of any of embodiments 1 to 41, wherein the reaction mixture continuously exiting the one or more continuous flow reactors displays a solids content ranging from 2 to 50 wt. % based on 100 wt.-% of the reaction mixture, preferably from 4 to 40 wt.-%, more preferably from 6 to 30 wt.-%, more preferably from 10 to 20 wt.-%, and more preferably from 13 to 15 wt.-% based on 100 wt.-% of the reaction mixture.

43. The continuous process of any of embodiments 1 to 42, wherein the zeolitic material further comprises X₂O₃ in its framework structure, wherein X stands for a trivalent element, and wherein the mixture in (i) further comprises one or more sources of X₂O₃.

44. The continuous process of embodiment 43, wherein X is selected from the group consisting of Al, B, In, Ga, and mixtures of two or more thereof, X preferably being Al and/or B, and more preferably being Al.

45. The continuous process of embodiment 43 or 44, wherein the one or more sources of SiO₂ and X₂O₃ comprises a first zeolitic material comprising SiO₂ and X₂O₃ in its framework structure, and
wherein in (iii) the mixture is heated in the one or more continuous flow reactors for obtaining a second zeolitic material comprising SiO₂ and X₂O₃ in its framework structure,
wherein the second zeolitic material obtained in (iii) has a different type of framework structure than the first zeolitic material contained in the mixture prepared in (i).

46. The continuous process of embodiment 45, wherein the first zeolitic material has an FAU-, GIS-, MOR-, LTA-, FER-, TON-, MTT-, BEA-, MEL-, MWW-, MFS-, and/or MFI-type framework structure, preferably an FAU-, GIS-, BEA-, and/or MFI-type framework structure, more preferably an FAU- and/or BEA-type framework structure, and more preferably an FAU-type framework structure.

47. The continuous process of embodiment 45 or 46, wherein the first zeolitic material having an FAU-type framework structure is selected from the group consisting of ZSM-3, Faujasite, [Al—Ge—O]-FAU, CSZ-1, ECR-30, Zeolite X, Zeolite Y, LZ-210, SAPO-37, ZSM20, Na—X, US-Y, Na—Y, [Gα-Ge—O]-FAU, Li-LSX, [Ga—Al—Si—O]-FAU, and [Ga—Si—O]-FAU, including mixtures of two or more thereof, preferably from the group consisting of ZSM-3, Faujasite, CSZ-1, ECR-30, Zeolite X, Zeolite Y, LZ-210, ZSM-20, Na—X, US-Y, Na—Y, and Li-LSX, including mixtures of two or more thereof, more preferably from the group consisting of Faujasite, Zeolite X, Zeolite Y, Na—X, US-Y, and Na—Y, including mixtures of two or more thereof, more preferably from the group consisting of Faujasite, Zeolite X, and Zeolite Y, including mixtures of two or more thereof, wherein more preferably the first zeolitic material having an FAU-type framework structure comprises zeolite X and/or zeolite Y, preferably zeolite Y, wherein more preferably the first zeolitic material having an FAU-type framework structure is zeolite X and/or zeolite Y, preferably zeolite Y.

48. The continuous process of any of embodiments 45 to 47, wherein the second zeolitic material has a CHA-, AEI-, GME-, and/or MFI-type framework structure, preferably a CHA and/or AEI-type framework structure, and more preferably a CHA-type framework structure.

49. The continuous process of any of embodiments 45 to 48, wherein the second zeolitic material obtained in (iii) has a CHA-type framework structure, wherein preferably the zeolitic material having a CHA-type framework structure is selected from the group consisting of Willhendersonite, ZYT-6, SAPO-47, Na-Chabazite, Chabazite, LZ-218, Linde D, Linde R, SAPO-34, ZK-14, K-Chabazite, MeAPSO-47, Phi, DAF-5, UiO-21, |Li—Na| [Al—Si—O]-CHA, (Ni(deta)2)-UT-6, SSZ-13, and SSZ-62, including mixtures of two or more thereof, more preferably from the group consisting of ZYT-6, SAPO-47, Na-Chabazite, Chabazite, LZ218, Linde D, Linde R, SAPO-34, ZK-14, K-Chabazite, Phi, DAF-5, UiO-21, SSZ-13, and SSZ-62, including mixtures of two or more thereof, more preferably from the group consisting of Chabazite, Linde D, Linde R, SAPO-34, SSZ-13, and SSZ-62, including mixtures of two or more thereof, more preferably from the group consisting of Chabazite, SSZ-13, and SSZ-62, including mixtures of two or three thereof, wherein more preferably the second zeolitic material obtained in (iii) comprises chabazite and/or SSZ-13, preferably SSZ13, and wherein more preferably the second zeolitic material obtained in (iii) is chabazite and/or SSZ-13, preferably SSZ-13.

50. The continuous process of any of embodiments 45 to 49, wherein independently from one another, the framework structure of the first zeolitic material displays a YO₂:X₂O₃ molar ratio ranging from 5 to 120, preferably from 8 to 80, more preferably from 10 to 50, more preferably from 15 to 40, more preferably from 20 to 30, more preferably from 22 to 28, and more preferably from 24 to 26.

51. The continuous process of any of embodiments 45 to 50, wherein the mixture prepared in (i) and heated in (iii) further comprises at least one source for OH⁻, wherein the mixture displays an OH⁻:SiO₂ molar ratio of hydroxide to SiO₂ in the framework structure of the first zeolitic material in the range of from 0.05 to 1, preferably from 0.1 to 0.7, more preferably from 0.3 to 0.6, more preferably from 0.4 to 0.55, more preferably from 0.45 to 0.5, more preferably from 0.46 to 0.49, and more preferably from 0.47 to 0.48.

52. The continuous process of any of embodiments 1 to 51, wherein the one or more solvents in the mixture prepared in (i) comprise water, preferably distilled water, wherein more preferably water is contained as the one or more solvents in the mixture prepared in (i), preferably distilled water.

53. The continuous process of embodiment 52, wherein the H₂O:SiO₂ molar ratio of water to SiO₂ calculated as the oxide in the mixture prepared in (i) is in the range of from 3 to 50, preferably of from 7 to 40, more preferably of from 9 to 30, more preferably of from 11 to 25, more preferably of from 13 to 22, more preferably of from 15 to 20, more preferably of from 16 to 19, and more preferably of from 17 to 18.

54. The continuous process of any of embodiments 1 to 53, wherein the mixture prepared in (i) and heated in (iii) further comprises at least one source for OH⁻, wherein said at least one source for OH⁻ preferably comprises a metal hydroxide, more preferably a hydroxide of an alkali metal M, more preferably sodium and/or potassium hydroxide, and more preferably sodium hydroxide, wherein more preferably the at least one source for OH⁻ is sodium hydroxide.

55. The continuous process of any of embodiments 1 to 54, wherein the mixture prepared in (i) further comprises seed crystals, wherein preferably the seed crystals comprise a zeolitic material having a CHA-, AEI-, GME-, and/or MFI-type framework structure, wherein more preferably the seed crystals comprise a zeolitic material having a CHA-type and/or an AEI-type framework structure, wherein more preferably the zeolitic material of the seed crystals is obtainable and/or obtained according to any one of embodiments 1 to 54.

56. The continuous process of embodiment 55, wherein the zeolitic material having a CHA-type framework structure comprised in the seed crystals is selected from the group consisting of Willhendersonite, ZYT-6, SAPO-47, Na-Chabazite, Chabazite, LZ-218, Linde D, Linde R, SAPO-34, ZK-14, K-Chabazite, MeAPSO-47, Phi, DAF-5, UiO-21, |Li-Na| [Al—Si—O]-CHA, (Ni(deta)2)-UT-6, SSZ-13, and SSZ-62, including mixtures of two or more thereof, preferably from the group consisting of ZYT-6, SAPO-47, Na-Chabazite, Chabazite, LZ-218, Linde D, Linde R, SAPO-34, ZK-14, K-Chabazite, Phi, DAF-5, UIO-21, SSZ-13, and SSZ-62, including mixtures of two or more thereof, more preferably from the group consisting of Chabazite, Linde D, Linde R, SAPO-34, SSZ-13, and SSZ-62, including mixtures of two or more thereof, more preferably from the group consisting of Chabazite, SSZ-13, and SSZ-62, including mixtures of two or three thereof, wherein more preferably the zeolitic material having a CHA-type framework structure comprised in the seed crystals is chabazite and/or SSZ-13, preferably SSZ-13.

57. The continuous process of embodiment 55 or 56, wherein the amount of seed crystals in the mixture prepared in (i) and heated in (iii) ranges from 0.1 to 25 wt.-% based on 100 wt.-% of SiO₂ in the framework structure of the first zeolitic material, preferably from 0.5 to 15 wt.-%, more preferably from 1 to 10 wt.-%, more preferably from 2 to 7 wt.-%, more preferably from 3 to 6 wt.-%, and more preferably from 4 to 5 wt.-% based on 100 wt.-% of SiO₂ in the framework structure of the first zeolitic material.

58. The continuous process of any of embodiments 1 to 57, wherein the one or more structure directing agents comprise one or more tetraalkylammonium cation R¹R²R³R⁴N⁺-containing compounds, wherein R¹, R², R³ and R⁴ independently from one another stand for alkyl.

59. The continuous process of embodiment 58, wherein R⁴ stands for adamantyl and/or benzyl, preferably for 1-adamantyl.

60. The continuous process of embodiment 59, wherein R¹, R², and R³ independently from one another stand for optionally substituted and/or optionally branched (C₁-C₆)alkyl, preferably (C₁-C₅)alkyl, more preferably (C₁-C₄)alkyl, more preferably (C₁-C₃)alkyl, and more preferably for optionally substituted methyl or ethyl, wherein more preferably R¹, R², and R³ independently from one another stand for optionally substituted methyl or ethyl, preferably unsubstituted methyl or ethyl, wherein more preferably R¹, R², and R³ independently from one another stand for optionally substituted methyl, preferably unsubstituted methyl.

61. The continuous process of embodiment 59 or 60, wherein R⁴ stands for optionally heterocyclic and/or optionally substituted adamantyl and/or benzyl, preferably for optionally heterocyclic and/or optionally substituted 1-adamantyl, more preferably for optionally substituted adamantyl and/or benzyl, more preferably for optionally substituted 1-adamantyl, more preferably for unsubstituted adamantyl and/or benzyl, and more preferably for unsubstituted 1-adamantyl.

62. The continuous process of any of embodiments 59 to 61, wherein the one or more tetraalkylammonium cation R¹R²R³R⁴N⁺-containing compounds comprise one or more N,N,N-tri(C₁-C₄)alkyl-1-adamantammonium compounds, preferably one or more N,N,N-tri(C₁-C₃)alkyl-1-adamantammonium compounds, more preferably one or more N,N,N-tri(C₁-C₂)alkyl-1-adamantammonium compounds, more preferably one or more N,N,N-tri(C₁-C₂)alkyl-1-adamantammonium and/or one or more N,N,N-tri(C₁-C₂)alkyl-1-adamantammonium compounds, more preferably one or more compounds selected from N,N,N-triethyl-1-adamantammonium, N,N-diethyl-N-methyl-1-adamantammonium, N,N-dimethyl-N-ethyl-1-adamantammonium, N,N,N-trimethyl-1-adamantammonium compounds, and mixtures of two or more thereof, wherein more preferably the one or more tetraalkylammonium cation R¹R²R³R⁴N⁺-containing compounds comprise one or more N,N,N-trimethyl-1-adamantammonium compounds.

63. The continuous process of any of embodiments 59 to 62, wherein the one or more tetraalkylammonium cation R¹R²R³R⁴N⁺-containing compounds are salts, preferably one or more salts selected from the group consisting of halides, sulfate, nitrate, phosphate, acetate, and mixtures of two or more thereof, more preferably from the group consisting of bromide, chloride, hydroxide, sulfate, and mixtures of two or more thereof, wherein more preferably the one or more tetraalkylammonium cation R¹R²R³R⁴N⁺-containing compounds are tetraalkylammonium hydroxides and/or sulfates, and more preferably tetraalkylammonium hydroxides.

64. The continuous process of embodiment 58, wherein R⁴ stands for cycloalkyl.

65. The continuous process of embodiment 64, wherein R¹ and R² independently from one another stand for optionally substituted and/or optionally branched (C₁-C₆)alkyl, preferably (C₁-C₅)alkyl, more preferably (C₁-C₄)alkyl, more preferably (C₁-C₃)alkyl, and more preferably for optionally substituted methyl or ethyl, wherein more preferably R¹ and R² independently from one another stand for optionally substituted methyl or ethyl, preferably unsubstituted methyl or ethyl, wherein more preferably R¹ and R² independently from one another stand for optionally substituted methyl, preferably unsubstituted methyl.

66. The continuous process of embodiment 64 or 65, wherein R³ stands for optionally substituted and/or optionally branched (C₁-C₆)alkyl, preferably (C₁-C₅)alkyl, more preferably (C₁-C₄)alkyl, more preferably (C₁-C₃)alkyl, and more preferably for optionally substituted methyl or ethyl, wherein more preferably R³ stands for optionally substituted ethyl, preferably unsubstituted ethyl.

67. The continuous process of any of embodiments 64 to 66, wherein R⁴ stands for optionally heterocyclic and/or optionally substituted 5- to 8-membered cycloalkyl, preferably for 5- to 7-membered cycloalkyl, more preferably for 5- or 6-membered cycloalkyl, wherein more preferably R⁴ stands for optionally heterocyclic and/or optionally substituted 6-membered cycloalkyl, preferably optionally substituted cyclohexyl, and more preferably unsubstituted cyclohexyl.

68. The continuous process of any of embodiments 64 to 67, wherein the one or more tetraalkylammonium cation R¹R²R³R⁴N⁺-containing compounds comprise one or more N,N,N-tri(C₁-C₄)alkyl-(C₅-C₇)cycloalkylammonium compounds, preferably one or more N,N,N-tri(C₁-C₃)alkyl-(C₅-C₆)cycloalkylammonium compounds, more preferably one or more N,N,N-tri(C₁-C₂)alkyl-(C₅-C₆)cycloalkylammonium compounds, more preferably one or more N,N,N-tri(C₁-C₂)alkyl-cyclopentylammonium and/or one or more N,N,N-tri(C₁-C₂)alkyl-cyclohexylammonium compounds, more preferably one or more compounds selected from N,N,N-triethyl-cyclohexylammonium, N,N-diethyl-N-methyl-cyclohexylammonium, N,N-dimethyl-N-ethyl-cyclohexylammonium, N,N,N-trimethyl-cyclohexylammonium compounds, and mixtures of two or more thereof, wherein more preferably the one or more tetraalkylammonium cation R¹R²R³R⁴N⁺-containing compounds comprise one or more N,N-dimethyl-N-ethyl-cyclohexylammonium compounds.

69. The continuous process of any of embodiments 64 to 68, wherein the one or more tetraalkylammonium cation R¹R²R³R⁴N⁺-containing compounds are salts, preferably one or more salts selected from the group consisting of halides, sulfate, nitrate, phosphate, acetate, and mixtures of two or more thereof, more preferably from the group consisting of bromide, chloride, hydroxide, sulfate, and mixtures of two or more thereof, wherein more preferably the one or more tetraalkylammonium cation R¹R²R³R⁴N⁺-containing compounds are tetraalkylammonium hydroxides and/or sulfates, and more preferably tetraalkylammonium hydroxides.

70. The continuous process of any of embodiments 64 to 69, wherein the one or more structure directing agents comprises one or more tetraalkylammonium cation R¹R²R³R⁴N⁺-containing compounds, and wherein the mixture prepared in (i) and heated in (iii) displays an R¹R²R³R⁴N⁺:SiO₂ molar ratio of the one or more tetraalkylammonium cations to SiO₂ in the framework structure of the first zeolitic material in the range of from 0.05 to 1.5, preferably from 0.1 to 0.8, more preferably from 0.3 to 0.5, more preferably from 0.5 to 0.3, more preferably from 0.7 to 0.2, more preferably from 0.8 to 0.15, more preferably from 0.85 to 0.12, more preferably from 0.9 to 0.11, and more preferably from 0.95 to 0.1.

71. The continuous process of any of embodiments 1 to 70, wherein in (iii) the mixture is heated to a temperature in the range of from 70 to 300° C., preferably of from 90 to 280° C., more preferably of from 120 to 250° C., more preferably of from 140 to 230° ° C., more preferably of from 160 to 220° C., more preferably of from 180 to 210° C., and more preferably of from 190 to 200° C.

72. The continuous process of any of embodiments 1 to 42, wherein the zeolitic material further comprises TiO₂ in its framework structure, wherein the mixture in (i) further comprises one or more sources of TiO₂, and wherein the one or more structure directing agents preferably comprise one or more tetraalkylammonium cation R¹R²R³R⁴N⁺-containing compounds, wherein R¹, R², R³ and R⁴ independently from one another stand for alkyl.

73. The continuous process of embodiment 72, wherein the zeolitic material obtained in (iii) has a framework structure type selected from the group consisting of MFI, MEL, IMF, SVY, FER, SVR, and intergrowth structures of two or more thereof, wherein preferably the zeolitic material obtained in (iii) has an MFI- and/or MEL-type framework structure, preferably an MFI-type framework structure.

74. The continuous process of embodiment 72 or 73, wherein the one or more solvents in the mixture prepared in (i) comprise water, preferably distilled water, wherein more preferably water is contained as the one or more solvents in the mixture prepared in (i), preferably distilled water.

75. The continuous process of embodiment 74, wherein the H₂O:Si molar ratio of water to the one or more sources of Si calculated as SiO₂ in the mixture prepared in (i) is in the range of from 2 to 13, preferably from 3 to 11, more preferably from 4 to 10, more preferably from 4.5 to 9.5, more preferably from 5 to 9, more preferably from 5.5 to 8.5, more preferably from 6 to 8, and more preferably from 6.5 to 7.5.

76. The continuous process of any of embodiments 72 to 75, wherein R¹, R², R³, and R⁴ independently from one another stand for optionally branched (C₁-C₆)alkyl, preferably (C₁-C₅)alkyl, more preferably (C₂-C₄)alkyl, and more preferably for optionally branched (C₂-C₃)alkyl, wherein more preferably R¹, R², R³, and R⁴ independently from one another stand for ethyl or propyl, wherein more preferably R¹, R², R³, and R⁴ stand for propyl, preferably for n-propyl.

77. The continuous process of any of embodiments 72 to 76, wherein independently of one another the one or more tetraalkylammonium cation R¹R²R³R⁴N⁺-containing compounds are salts, preferably one or more salts selected from the group consisting of halides, preferably chloride and/or bromide, more preferably chloride, hydroxide, sulfate, nitrate, phosphate, acetate, and mixtures of two or more thereof, more preferably from the group consisting of chloride, hydroxide, sulfate, and mixtures of two or more thereof, wherein more preferably the one or more tetraalkylammonium cation R¹R²R³R⁴N⁺-containing compounds are tetraalkylammonium hydroxides and/or chlorides, and more preferably tetraalkylammonium hydroxides.

78. The continuous process of any of embodiments 72 to 77, wherein the mixture prepared in (i) and crystallized in (iii) displays a molar ratio of the one or more tetraalkylammonium cation R¹R²R³R⁴N⁺-containing compounds to the one or more sources of Si calculated as SiO₂ in the range of from 0.001 to 1.5, preferably from 0.005 to 1, more preferably from 0.01 to 0.7, more preferably from 0.05 to 0.5, more preferably from 0.07 to 0.4, more preferably from 0.1 to 0.3, more preferably from 0.13 to 0.25, more preferably from 0.15 to 0.22, and even more preferably from 0.17 to 0.19.

79. The continuous process of any of embodiments 72 to 78, wherein the one or more sources of SiO₂ comprises one or more compounds selected from the group consisting of silicas, silicates, and mixtures thereof,
preferably from the group consisting of fumed silica, silica hydrosols, reactive amorphous solid silicas, silica gel, silicic acid, water glass, sodium metasilicate hydrate, sesquisilicate, disilicate, colloidal silica, pyrogenic silica, silicic acid esters, tetraalkoxysilanes, and mixtures of two or more thereof,
more preferably from the group consisting of silica hydrosols, silica gel, silicic acid, water glass, sodium metasilicate hydrate, colloidal silica, silicic acid esters, tetraalkoxysilanes, and mixtures of two or more thereof,
more preferably from the group consisting of silica hydrosols, silicic acid, colloidal silica, silicic acid esters, tetraalkoxysilanes, and mixtures of two or more thereof,
wherein more preferably the one or more sources of SiO₂ comprise one or more tetraalkoxysilanes selected from the group consisting of (C₁-C₆)tetraalkoxysilanes and mixtures of two or more thereof, preferably (C₁-C₅)tetraalkoxysilanes and mixtures of two or more thereof, more preferably (C₁-C₄)tetraalkoxysilanes and mixtures of two or more thereof, more preferably (C₁-C₃)tetraalkoxysilanes and mixtures of two or more thereof, wherein more preferably the one or more sources of SiO₂ comprise tetramethoxysilane and/or tetraethoxysilane, preferably tetraethoxysilane, and wherein more preferably the one or more sources of Si is tetramethoxysilane and/or tetraethoxysilane, preferably tetraethoxysilane.

80. The continuous process of any of embodiments 72 to 79, wherein the one or more sources of Ti comprises one or more compounds selected from the group consisting of titanium oxides, titanium salts, titanyl compounds, titanic acids, titanic acid esters, and mixtures of two or more thereof, preferably one or more compounds selected from the group consisting of tetrabutyl orthotitanate, tetraisopropyl orthotitanate, tetraethyl orthotitanate, titanium dioxide, titanium tetrachloride, titanium tert-butoxide, TiOSO₄ and/or KTiOPO₄, and a mixture of two or more thereof, more preferably from the group consisting of tetrabutyl orthotitanate, tetraisopropyl orthotitanate, tetraethyl orthotitanate, titanium dioxide, titanium tetrachloride, titanium tert-butoxide, and a mixture of two or more thereof, the titanium source preferably being tetramethyl and/or tetraethyl orthotitanate, more preferably tetraethyl orthotitanate.

81. The continuous process of any of embodiments 72 to 80, wherein the SiO₂:TiO₂ molar ratio of the one or more sources of SiO₂, calculated as SiO₂, to the one or more sources of TiO₂, calculated as TiO₂, of the mixture prepared in (i) ranges from 1 to 500, preferably from 2 to 200, more preferably from 5 to 150, more preferably from 10 to 100, more preferably from 20 to 70, more preferably from 25 to 50, more preferably from 30 to 45, and more preferably from 35 to 40.

82. The continuous process of any of embodiments 72 to 81, wherein in (iii) the mixture is heated to a temperature in the range of from 90 to 280° C., preferably of from 110 to 250° C., more preferably of from 130 to 220° C., more preferably of from 150 to 200° C., more preferably of from 160 to 190° C., and more preferably of from 170 to 180ºC.

83. The continuous process of any of embodiments 72 to 82, wherein prior to (ii) the mixture prepared in (i) is aged at a temperature in the range of from 40 to 120° C., preferably from 50 to 115° C., more preferably from 60 to 110° C., more preferably from 70 to 105° C., more preferably from 80 to 100° C., and more preferably from 85 to 95° C.

84. The continuous process of any of embodiments 72 to 83, wherein prior to (ii) the mixture prepared in (i) is aged for a duration ranging from 0.05 to 48 h, more preferably from 0.15 to 24 h, more preferably from 0.25 to 12 h, more preferably from 0.5 to 6 h, more preferably from 0.75 to 3 h, more preferably from 1 to 2 h, and more preferably from 1.25 to 1.75 h.

85. The continuous process of any of embodiments 1 to 84, wherein the process further comprises
(iv) concentrating the zeolitic material obtained in (iii), preferably by filtration, more preferably by membrane filtration, and more preferably by cross-flow filtration;
and/or, preferably and,
(v) washing the zeolitic material obtained in (iii) or (iv) with a liquid comprising one or more solvents;
and/or, preferably and,
(vi) drying the zeolitic material obtained in (iii), (iv) or (v);

and/or, preferably and,
(vii) calcining the zeolitic material obtained in (iii), (iv), (v) or (vi).

86. The continuous process of embodiment 85, wherein concentrating in (iv) and washing in (v) is performed simultaneously in two or more sequential stages of membrane filtration, preferably in 2 to 10 stages, more preferably from 3 to 8, more preferably from 3 to 7, more preferably from 4 to 6, and more preferably from 4 to 5, wherein the retentate of one stage of membrane filtration is diluted with the liquid comprising one or more solvents when being fed to the subsequent stage.

87. The continuous process of embodiment 86, wherein the permeate of the first stage of membrane filtration comprising a portion of the one or more structure directing agents from the mixture continuously prepared in (i) is continuously recycled to (i).

88. The continuous process of any of embodiments 85 to 87, wherein membrane filtration is conducted at a pressure in the range of from 0.2 to 60 bar, preferably from 0.5 to 20 bar, more preferably of from 1 to 15 bar, more preferably of from 3 to 12 bar, and more preferably of from 5 to 8 bar.

89. The continuous process of any of embodiments 85 to 88, wherein membrane filtration is conducted at a temperature in the range of from 20 to 200° C., preferably in the range of from 50 to 150° C., more preferably from 80 to 120° C., more preferably from 90 to 110° C., and more preferably from 97 to 103° C.

90. The continuous process of any of embodiments 85 to 89, wherein the membrane filtration is a cross-flow filtration.

91. The continuous process of embodiment 90, wherein the cross-flow filtration is performed in one or more sequential cross-flow filtration units, preferably in 1 to 10 sequential cross-flow filtration units, more preferably in 2 to 9 sequential cross-flow filtration units, more preferably in 3 to 8 sequential cross-flow filtration units, more preferably in 4 to 6 sequential cross-flow filtration units, and more preferably in 4 to 5 sequential cross-flow filtration units.

92. The continuous process of embodiment 91, wherein each of the one or more sequential cross-flow filtration units comprises from 10 to 10,000 tubes, preferably from 250 to 7,500 tubes, more preferably from 500 to 5,000 tubes, more preferably from 750 to 2,500 tubes, and more preferably from 975 to 1025 tubes.

93. The continuous process of embodiment 92, wherein the inner diameter of the tubes is in the range of from 2 to 25 mm, preferably in the range of from 3 to 20 mm, more preferably form 4 to 15 mm, more preferably from 5 to 10 mm, and more preferably from 5.5 to 6.5 mm.

94. The continuous process of any of embodiments 85 to 93, wherein in (v) the liquid comprises one or more solvents selected from the group consisting of polar protic solvents and mixtures thereof, preferably from the group consisting of n-butanol, isopropanol, propanol, ethanol, methanol, water, and mixtures thereof, more preferably from the group consisting of ethanol, methanol, water, and mixtures thereof, wherein more preferably the liquid comprises water, and wherein more preferably water is used as the liquid, preferably deionized water.

95. The continuous process of any of embodiments 85 to 94, wherein drying in (vi) is effected at a temperature in the range from 50 to 220° C., preferably from 70 to 190° C., more preferably from 80 to 170° C., more preferably from 90 to 150° C., more preferably from 100 to 140° C., and more preferably from 110 to 130° C.

96. The continuous process of any of embodiments 85 to 95, wherein in (vi) drying of the zeolitic material includes a step of spray-drying the zeolitic material obtained in (iii), (iv) or (v).

97. The continuous process of embodiment 96, wherein spray drying is effected with a drying gas having a temperature in the range from 100 to 500° C., preferably from 150 to 450° C., more preferably from 200 to 400° C., more preferably from 250 to 350° C., and more preferably from 275 to 325° C.

98. A zeolitic material as obtainable and/or obtained according to the process of any one of embodiments 1 to 97.

99. The zeolitic material of embodiment 98, wherein the zeolitic material has a CHA-type framework structure, wherein preferably the zeolitic material is selected from the group consisting of Willhendersonite, ZYT-6, SAPO-47, Na-Chabazite, Chabazite, LZ-218, Linde D, Linde R, SAPO-34, ZK-14, K-Chabazite, MeAPSO-47, Phi, DAF-5, UIO-21, |Li-Na| [Al—Si—O]-CHA, (Ni(deta)2)-UT-6, SSZ-13, and SSZ-62, including mixtures of two or more thereof, more preferably from the group consisting of ZYT-6, SAPO-47, Na-Chabazite, Chabazite, LZ-218, Linde D, Linde R, SAPO-34, ZK-14, K-Chabazite, Phi, DAF-5, UIO-21, SSZ-13, and SSZ-62, including mixtures of two or more thereof, more preferably from the group consisting of Chabazite, Linde D, Linde R, SAPO-34, SSZ-13, and SSZ-62, including mixtures of two or more thereof, more preferably from the group consisting of Chabazite, SSZ-13, and SSZ-62, including mixtures of two or three thereof, wherein more preferably the zeolitic material comprises chabazite and/or SSZ-13, preferably SSZ-13, and wherein more preferably the zeolitic material is chabazite and/or SSZ-13, preferably SSZ13.

100. Use of a zeolitic material according to embodiments 98 or 99 as a molecular sieve, as an adsorbent, for ion-exchange, or as a catalyst and/or as a catalyst support, preferably as a catalyst and/or catalyst support for the selective catalytic reduction (SCR) of nitrogen oxides NOₓ; for the storage and/or adsorption of CO₂; for the oxidation of NH₃, in particular for the oxidation of NH₃ slip in diesel systems; for the decomposition of N₂O; as an additive in fluid catalytic cracking (FCC) processes; and/or as a catalyst and/or catalyst support in organic conversion reactions, preferably in the conversion of alcohols to olefins, and more preferably in methanol to olefin (MTO) catalysis; more preferably for the selective catalytic reduction (SCR) of nitrogen oxides NOₓ, and more preferably for the selective catalytic reduction (SCR) of nitrogen oxides NOₓ in exhaust gas from a combustion engine, preferably from a diesel engine or from a lean burn gasoline engine.

101. The zeolitic material of embodiment 98, wherein the zeolitic material has an MFI-type framework structure, wherein the zeolitic material having an MFI-type framework structure comprises TS-1, wherein more preferably the zeolitic material is TS-1.

102. Use of a zeolitic material according to embodiment 98 or 101 as a molecular sieve, as an adsorbent, for ion-exchange, or as a catalyst and/or as a catalyst support, preferably as a catalyst and/or catalyst support in a reaction involving C—C bond formation and/or conversion, and preferably as a catalyst and/or catalyst support in an isomerization reaction, in an ammoxidation reaction, in an amination reaction, in a hydrocracking reaction, in an alkylation reaction, in an acylation reaction, in a reaction for the conversion of alkanes to olefins, or in a reaction for the conversion of one or more oxygenates to olefins and/or aromatics, in a reaction for the synthesis of hydrogen peroxide, in an aldol condensation reaction, in a reaction for the isomerization of epoxides, in a transesterification reaction, or in an epoxidation reaction, preferably as a catalyst and/or catalyst support in a reaction for the epoxidation of olefins, more preferably in a reaction for the epoxidation of C₂-C₅ alkenes, more preferably in a reaction for the epoxidation of C₂-C₄ alkenes, in a reaction for the epoxidation of C₂ or C₃ alkenes, more preferably for the epoxidation of C₃ alkenes, and more preferably as a catalyst for the conversion of propylene to propylene oxide.

### Experimental Section

The present invention is further illustrated by the following examples and reference examples.

### Reference Example 1: Preparation of Seed Crystals Having a CHA-Type Framework Structure

194.5 g of deionized water and 943.1 g of a solution of 1-adamantyltrimethylammonium hydroxide (AdaTMAOH) (20.17 wt.-% aqueous solution obtained from BASF) were placed in a flask and treated with 86.4 g of a solution of sodium hydroxide (50 wt.-% aqueous solution) thus obtaining a clear solution. 28.1 g of aluminum hydroxide (obtained from Sigma Aldrich) were then added stepwise and the resulting mixture then stirred for 30 min at room temperature for obtaining a milky solution. 901.3 g of Ludox SM 30 (30 wt.-% SiO₂ suspension in water obtained from Sigma Aldrich) were then added under stirring during which the viscosity of the mixture increased. The suspension displaying molar ratios of SiO₂:Al(OH)₃:NaOH:AdaTMAOH of 1:0.04:0.24:0.20 was then stirred for a further 30 min at room temperature.

The reaction mixture was then placed in an autoclave with a volume of 2.5 L and then heated under stirring (200 rpm) in 45 min to 160° C., after which it was held at that temperature for 120 min. The maximum pressure measured in the autoclave during the reaction was 0.5 MPa (5 bar). After the synthesis, the suspension was filtered off and the solid product washed with distilled water. The filter cake (214.8 g) was then dried in a recirculating air oven at 120° C. over night for affording a crystalline product.

The framework structure was determined via X-ray diffraction pattern as being CHA-type. The crystallinity was calculated to be 52% based on the X-ray diffractogramm of the sample in question. The mean particle size D50 by volume as determined according to ISO 13320:2009 was 150 μm, and the particle size D10 and D90 was 12 μm and 504 μm respectively.

Elemental analysis of the product afforded: C: 15.7%, Al: 2.3%, Na: 0.37%, Si: 34%.

### Reference Example 2: Preparation of Synthesis Gel for the Continuous Synthesis of a Zeolitic Material Having a CHA-Type Framework Structure

423.3 g of an aqueous solution of cyclohexyltrimethylammonium hydroxide (CHTMAOH) (20 wt.-% aqueous solution from BASF) and 123.7 g of an aqueous solution of tetramethylammonium hydroxide (TMAOH) (25 wt.-% aqueous solution obtained from Sachem) were placed in a 2 L quadruple neck round bottom flask. 16.9 g of aluminum hydroxide (obtained from Wako) were then added stepwise and the resulting mixture then stirred for 45 min at room temperature for obtaining a white suspension. 450.0 g Ludox AS 40 (40 wt.-% SiO₂ suspension in water obtained from Grace) were then added under stirring and the resulting mixture then stirred for additional 15 min. 18.0 g of the crystalline product obtained from Reference Example 1 were then added, and the resulting mixture displaying molar ratios of SiO₂:Al(OH)₃:CHTMAOH:TMAOH:H₂O=1:0.072:0.177:0.113:13 was then heated to 85° C. and stirred (270 rpm) at that temperature over night for affording an aged gel.

### Example 1: Simulation of a Continuously Operated Reactor

The preparation of a zeolitic material having CHA framework structure was simulated by means of Computational Fluid Dynamics (CFD). Fluent® was used therefor.

The synthesis gel according to Reference Example 2 was considered for the simulation.

Generally, the chabazite formation starts with an aqueous mixture with a decrease of viscosity during heat up. Further heating induces a transition to a gel phase with a non-Newtonian behavior. Thus, the viscosity was assumed as indicator for the reaction progress. Once the zeolite formation progresses the rheology changes back to Newtonian and viscosity drops significantly. This was shown by previous experiments to happen after several hours after start-up. The results for said experiments are shown in FIG. 1.

The linear increase in the half-logarithmic chart was assumed as a simple reaction of first order of type r=−k*[gel].

In table 1 the parameters are listed which were set for the simulation.

TABLE 1
Rheology and kinetics used in CFD simulation.

| | | |
|---|---|---|
| Viscosity | v = k · (\dot{y}/1.667)^{-k/10} | Viscosity of |
| [Pas] | k = 8272 · (1 − exp(−0.1379 · T)) − | pure gel |
| | 8265 | |
| | T = Temperature [° C.] | |
| Transition | r = −k · [Cₚᵣₑ] | Cₚᵣₑ: |
| kinetics | k = 1 · 10¹⁵ · exp(1.15 · 10⁸/RT) | concentration of |
| [kmol/m³ · s] | | aqueous solution |

A CFD simulation was set up to identify the actual shear rates in the tubular reactor in the pulsating mode (also referred to as “Piff-Paff”-mode, named after the sound of the flow control valves) to understand the shear rates needed for a stable operation. The reactor setting is described in detail in Example 1 b) of WO 2021/122533 A1. The feed is modelled as aqueous fluid. This fluid is converted to gel via the above given reaction kinetic. In the CFD simulation tool the aqueous feed is modelled as water. The gel is defined with the same material properties as water except the non-Newtonian rheology.

As for an experimental setup filling of the reactor with an inert oil fill was implemented in the simulation. The pressurized tank which is typically provided upstream the heated reactor can be omitted in the simulation, the feed is directly applied to the inlet of the tubular reactor. The “Piff-Paff” mode is modelled as alternating flow and no-flow inlet boundary condition.

The flow velocity for the open valve (flow) mode was based on the average flow rate of 300 mL/h. In the actual operation, flow is applied for only 0.5 s while for 39.5 s inlet and outlet are blocked such that no flow passes the system. This means that the actual flow rate during the short open-flow period is 80 times larger than the time average flow rate. For the given system this results in an actual flow velocity of 0.11 m/s.

In the first section the boundary conditions for the feed flow were set. The inlet was defined as a velocity inlet with constant velocity, here 0.11 m/s (set directly in Fluent®) and the outlet was set as a pressure outlet. This condition is kept for 0.5 s simulated in time steps of 0.05 s. Consecutively, the no flow conditions define both inlet and outlet as walls. This condition is hold for 39.5 s at a simulation time step of 0.5 s.

Important results of the simulation are shown in FIGS. 2-3. In FIG. 2, a situation under flow condition (open valve) is shown, in FIG. 3 no flow is shown (valves closed). For each situation the gel mass fraction and the corresponding viscosity is presented. As can be gathered from FIGS. 2-3, the transition of the feed to gel phase happens already in the 90° bend of the feed tube. A shear rate of 220 s⁻¹ was found to be preferred.

If the mixture is in motion the viscosity shows moderate values. Once the valves are closed and the mixture is at rest the viscosity increases noteworthy. This is due to the non-Newtonian (here shear-thinning) nature of the gel.

An option to overcome this issue is the application of a pulsator device. A pulsator does not affect the mass flow but keeps the liquid moving back and forth in the tubular reactor. Due to the non-Newtonian rheology, CFD methods were used for the design of such a pulsator. In a study it was investigated if the modeled system can be simplified. Therefore, it was tested if the shear rates found in the simulation of the full tubular reactor can be reproduced in a model of a short tube. This was tested successfully and some results are summarized in table 2.

TABLE 2
Shear rates comparison between full
tubular reactor and simplified tube.

| Max. shear rates [s⁻¹] | Full tubular reactor | Simplified tube |
|---|---|---|
| Gel | 220 | 220 |
| H₂O | — | 150 |

By including the non-Newtonian rheology in the test with the simplified tube an optimized shear rate can be accessed. By simulation of the pulsator, the necessary pulsation velocity profile can be identified. This information can then be used to design the pulsator and its operation, e.g. size, pass and frequency. A shear rate of 220 s⁻¹ corresponds to a diameter of reactor tube of 6.2 mm and a gel flow rate of 3.3⋅×10⁻⁶ m³/s. The pulsator needs to provide this velocity. For a given tube diameter the size, pass length and the frequency of a pulsator can then be determined. Two pulsator systems are reviewed and the calculated frequencies for these are shown in table 3.

TABLE 3
Calculated frequencies for two differently sized
pulsators to achieve the required shear rate.

| | Diameter 3 mm | Diameter 20 mm |
|---|---|---|
| | Pass 7 mm | Pass 10 mm |
| Frequency [s⁻¹] | 21 | 0.333 |

In sum, it was found that the preparation of a zeolitic material in a semi-continuously operated tubular reactor with alternating flow patterns (“Piff-Paff” mode) allows for stable zeolite conversion while slow constant flow rates seem to cause issues, i.e. blocking of the reactor.

### BRIEF DESCRIPTION OF FIGURES

FIG. 1: shows results from viscosity measurements at ambient temperatures for the synthesis gel according to Reference Example 2.

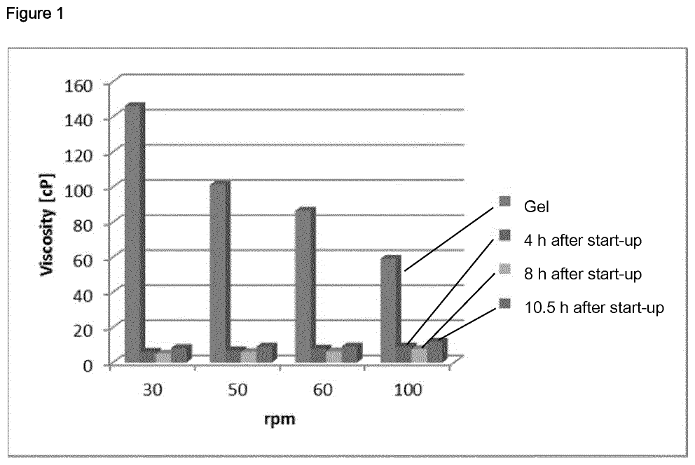

FIG. 2: shows simulation results for the “Piff-paff” mode in flow condition. The zeolite mass fraction and the corresponding dynamic viscosity are shown.

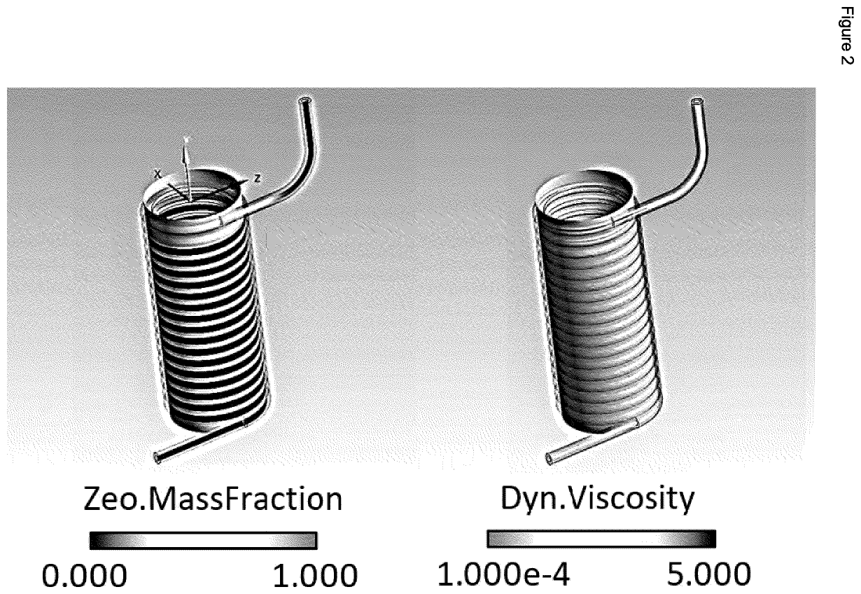

FIG. 3: shows simulation results for the “Piff-paff” mode when no flow is applied. The zeolite mass fraction and the corresponding dynamic viscosity are shown.

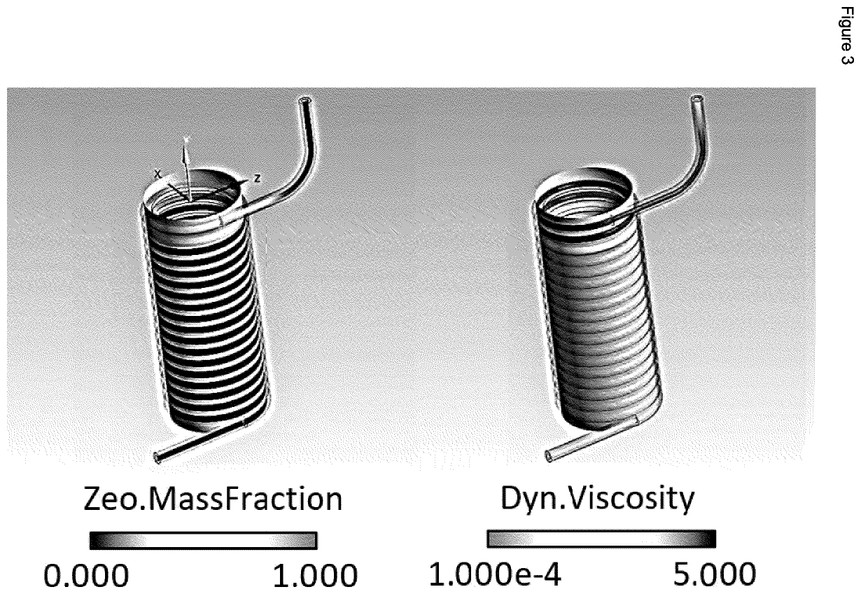

### CITED PRIOR ART LITERATURE

US 2016/0115039 A1
Liu et al. in Angew. Chem. Int. Ed. 2015, 54, 5683-5687
Ju, J. et al. in Chemical Engineering Journal 2006, 116, 115-121
Vandermeersch, T. et al. in Microporous and Mesoporous Materials 2016, 226, 133-139
Liu, Z. et al. in Chemistry of Materials 2014, 26, 2327-2331
Slangen et al. “Continuous Synthesis of Zeolites using a Tubular Reactor”, 12th International
Zeolite Conference, Materials Research Society 1999
Bonaccorsi, L. et al. in Microporous and Mesoporous Materials 2008, 112, 481-493
US 2001/0054549 A1
WO 2020/109292 A1
WO 2020/025799 A
WO 2019/101854 A

1.-15. (canceled)

16. A continuous process for the preparation of a zeolitic material comprising SiO₂ in its framework structure, said process comprising
(i) continuously preparing a mixture comprising one or more solvents, one or more structure directing agents, and one or more sources of SiO₂;
(ii) continuously feeding the mixture prepared in (i) into one or more continuous flow reactors; and
(iii) heating the mixture in the one or more continuous flow reactors for continuously obtaining a zeolitic material comprising SiO₂ in its framework structure;
wherein the mixture contained in the one or more continuous flow reactors is subject to a pulsatile flow regime.

17. The continuous process of claim 16, wherein in (ii) the mixture continuously prepared in (i) is continuously fed into the one or more continuous flow reactors at a rate of from 10 to 2,000 kg/h.

18. The continuous process of claim 16, wherein in (ii), the mixture continuously prepared in (i) is continuously fed into 1 to 10 continuous flow reactors.

19. The continuous process of claim 16, wherein the pulsatile flow regime is achieved by a semi-continuous flow regime in, or in and against, the general direction of flow, wherein the general direction of flow is defined by an inlet end of each of the one or more continuous flow reactors into which the mixture prepared in (i) is continuously fed and an outlet end of each of the one or more continuous flow reactors from which the zeolitic material obtained in (iii) is continuously collected.

20. The continuous process of claim 19, wherein the pulsatile flow regime is achieved by a pulsating movement in, or in and against, the general direction of flow.

21. The continuous process of claim 20, wherein the frequency of the pulsation is in the range of from 0.001 to 1 s⁻¹.

22. The continuous process of claim 16, wherein in (iii) the mixture is heated to a temperature in the range of from 90 to 280° C.

23. The continuous process of claim 16, wherein in (iii) the mixture is heated under autogenous pressure.

24. The continuous process of claim 16, wherein in (ii) the mixture prepared in (i) is continuously fed into the one or more continuous flow reactors for a duration ranging from 5 to 365 d.

25. The continuous process of claim 16, wherein each of the one of more continuous flow reactors is selected among a tubular reactor, a ring reactor, and a continuously oscillating reactor.

26. The continuous process of claim 16, wherein the zeolitic material further comprises X₂O₃ in its framework structure, wherein X stands for a trivalent element, and wherein the mixture in (i) further comprises one or more sources of X₂O₃.

27. The continuous process of claim 26, wherein X is selected from the group consisting of Al, B, In, Ga, and mixtures of two or more thereof.

28. The continuous process of claim 16, wherein the zeolitic material further comprises TiO₂ in its framework structure, and wherein the mixture in (i) further comprises one or more sources of TiO₂.

29. A zeolitic material as obtainable and/or obtained according to the process of claim 16.

30. Use of a zeolitic material according to claim 29 as a molecular sieve, as an adsorbent, for ion-exchange, or as a catalyst and/or as a catalyst support.
